(19) United States
(12) Patent Application Publication
(10) Pub. No.: US 2026/0250814 A1
(43) Pub. Date: Aug. 27, 2026

(54) STEEL SHEET, MEMBER, AND PART, AND METHODS OF PRODUCING SAME

(71) Applicant: JFE STEEL CORPORATION, Chiyoda-ku, Tokyo (JP)

(72) Inventors: Yusuke WADA, Chiyoda-ku, Tokyo (JP); Hidekazu MINAMI, Chiyoda-ku, Tokyo (JP); Yuki TOJI, Chiyoda-ku, Tokyo (JP)

(73) Assignee: JFE STEEL CORPORATION, Chiyoda-ku, Tokyo (JP)

(21) Appl. No.: 19/489,697

(22) PCT Filed: Jun. 3, 2024
(86) PCT No.: PCT/JP2024/020266

§ 371 Date: Dec. 3, 2025

(30) Foreign Application Priority Data
Jul. 12, 2023 (JP) 2023-114782

(51) Int. Cl. C22C 38/04; B62D 29/00; C21D 6/00; C21D 8/0221; C21D 8/0247; C21D 8/0278; C21D 9/46; C22C 38/00; C22C 38/02; C22C 38/06; C23C 2/06

(52) U.S. Cl. CPC C22C 38/04; B62D 29/007; C21D 6/005; C21D 8/0226; C21D 8/0236; C21D 8/0273; C21D 8/0278; C21D 9/46; C22C 38/001; C22C 38/002; C22C 38/02; C22C 38/06; C23C 2/06; C21D 2211/001; C21D 2211/002; C21D 2211/005; C21D 2211/008; C21D 2211/009

(57) ABSTRACT

Provided is a high-strength steel sheet that is excellent in all of member strength, stretch flangeability, bendability, and delayed fracture resistance under atmospheric corrosion conditions in the coated state. The steel sheet has a predetermined chemical composition and microstructure, where an average value [τq] of plastic deformation initiation stress τq measured by a nanoindentation method at the ¼ thickness position of the steel sheet is 2.50 GPa or more and 4.10 GPa or less, standard deviation σq of the τq is 0.30 GPa or less, and when an average value of plastic deformation initiation stress τs measured by a nanoindentation method at the 10 μm position from the steel sheet surface is defined as [τs], the proportion of measurement points having values less than 0.85×[τs] is 25.0% or less.

### TECHNICAL FIELD

The present disclosure relates to a steel sheet, and particularly to a high-strength steel sheet and a method of producing the same, the steel sheet being excellent in all of member strength, stretch flangeability, bendability, and delayed fracture resistance under atmospheric corrosion conditions in a coated state. The steel sheet of the present disclosure can be suitably used as a structural member for an automotive part or the like.

### BACKGROUND

To achieve both the reduction of CO₂ emissions through vehicle weight reduction and the improvement of crashworthiness, the strengthening of thin steel sheets for automobiles has been progressing, along with the successive introduction of new regulations.

Accordingly, in major structural parts forming the frame of automobile cabins, applications of high-strength steel sheets having a tensile strength (TS) of 1180 MPa class or higher have been increasing.

High-strength steel sheets used for automotive reinforcement parts and frame structural parts are sometimes required to provide high strength in the parts. In such cases, it is desirable to achieve a high yield ratio (YR=yield strength YS/tensile strength TS×100). Further, since parts such as crash boxes have punched end surfaces and bent portions, steel sheets used for these parts are also required to have excellent stretch flangeability and bendability.

However, in high-strength steel sheets having a tensile strength of 1180 MPa class or higher, there arises a problem of delayed fracture, in which a member suddenly fractures due to hydrogen penetration under atmospheric corrosion environments where automobiles are operated.

That is, in automotive steel sheets, stress is applied during press forming or part assembly, and subsequently, there exists a risk of hydrogen penetration from the environment into the steel sheet. Accordingly, it is required to improve the delayed fracture resistance of the high-strength steel sheets.

Furthermore, in automotive parts, the risk of delayed fracture initiation is high at bent portions and sheared end surface portions. Therefore, it is required to improve the delayed fracture resistance of bent portions having sheared end surface portions.

In particular, automotive parts are exposed to atmospheric corrosion environments in a coated state. The coated state inevitably involves defects in the coating, which is different from the uncoated state. Under environments where wet-dry cycles occur, localized corrosion progresses in the steel sheet surface layer starting from the coating defect, from which hydrogen penetrates, possibly leading to delayed fracture.

Therefore, improvement in the delayed fracture resistance of bent portions having sheared end surfaces in a coated state under environments with wet-dry cycles (hereinafter also referred to as “delayed fracture resistance under atmospheric corrosion conditions in the coated state”) is required. Thus, to increase the application ratio of high-strength steel sheets to automotive parts, it is desired to comprehensively satisfy the various properties mentioned above.

In response to the above requirements, for example, WO 2018/011978 (PTL 1) describes an ultra-high-strength cold-rolled steel sheet and a method of producing the same, the steel sheet exhibiting excellent hydrogen embrittlement resistance and having a tensile strength of 1300 MPa or higher.

### CITATION LIST

### Patent Literature

PTL 1: WO 2018/011978

### SUMMARY

### Technical Problem

The high-strength steel sheet described in PTL 1 exhibits excellent delayed fracture resistance at punched end surfaces in a hydrochloric acid aqueous solution of pH 1. However, the delayed fracture properties in the coated state under environmental conditions of repetition of wet and dry cycles between day and night, which is typical of atmospheric corrosion environments, have not been taken into consideration.

Therefore, to broadly apply high-strength steel sheets to automotive parts, it is required to improve the delayed fracture resistance under atmospheric corrosion conditions in the coated state, in addition to excellent member strength, stretch flangeability, and bendability.

It could thus be helpful to provide a high-strength steel sheet that is excellent in all of member strength, stretch flangeability, bendability, and delayed fracture resistance under atmospheric corrosion conditions in the coated state, and to provide an advantageous method of producing the high-strength steel sheet. Further, it could also be helpful to provide a member containing the high-strength steel sheet, and an automotive frame structural part or an automotive reinforcement part using the member.

In the present disclosure, the term “high-strength steel sheet” means a steel sheet having a tensile strength (TS) of 1180 MPa or more, as determined by a tensile test described later.

The expression “excellent in member strength” means that the yield ratio (YR), determined by a tensile test described later, is more than 75%.

The expression “excellent in stretch flangeability” means that the hole expansion ratio (λ), determined by a hole expanding test described later, is 30% or more.

The expression “excellent in bendability” means that the limit bending radius (R/t), determined by a bending test described later, is 5.0 or less.

The expression “excellent in delayed fracture resistance under atmospheric corrosion conditions in the coated state” means that after subjecting a test piece having a sheared end surface, as described later, to bending and stress loading to prepare a delayed fracture test piece, and then subjecting the delayed fracture test piece to chemical conversion electrodeposition coating, no cracking is observed on the delayed fracture test piece after 30 days in a corrosion cycle test involving repeated wet and dry cycles.

### Solution to Problem

As a result of extensive studies, we have found that the above objective can be achieved by adopting the configuration described below, thus completing the present disclosure.

Specifically, primary features of the present disclosure are as follows.

1. A steel sheet, comprising a chemical composition containing (consisting of), in mass %, C: 0.090% or more and 0.390% or less, Si: 0.01% or more and 2.00% or less, Mn: 2.00% or more and 4.00% or less, P: 0.100% or less, S: 0.0200% or less, Al: 1.000% or less, N: 0.0100% or less, and O: 0.0100% or less, with the balance being Fe and inevitable impurities, wherein,
at a ¼ thickness position of the steel sheet, the steel sheet comprises a microstructure satisfying:
an area ratio of tempered martensite is 75% or more,
an area ratio of fresh martensite is 15% or less,
a total area ratio of ferrite and bainite is 15% or less,
an area ratio of retained austenite is 15% or less, and
an average value [τq] of plastic deformation initiation stress τq measured by a nanoindentation method at the ¼ thickness position is 2.50 GPa or more and 4.10 GPa or less, and standard deviation σq of the plastic deformation initiation stress τq is 0.30 GPa or less, and
at a 10 μm position from a steel sheet surface, the steel sheet comprises a microstructure satisfying:
an area ratio of tempered martensite is 40% or less,
an area ratio of pearlite is 15% or less,
a total area ratio of ferrite and bainite is 60% or more, and
when an average value of plastic deformation initiation stress τs measured by a nanoindentation method at the 10 μm position is defined as [τs], a proportion of measurement points having values less than 0.85×[τs] is 25.0% or less.

2. The steel sheet according to the above 1., wherein the chemical composition further contains, in mass %, at least one element selected from the group consisting of: Ti: 0.200% or less, Nb: 0.200% or less, V: 0.200% or less, Ta: 0.10% or less, W: 0.10% or less, B: 0.0100% or less, Cr: 1.00% or less, Mo: 1.00% or less, Ni: 1.00% or less, Co: 0.010% or less, Cu: 1.00% or less, Sn: 0.200% or less, Sb: 0.200% or less, Ca: 0.0100% or less, Mg: 0.0100% or less, REM: 0.0100% or less, Zr: 0.100% or less, Te: 0.100% or less, Hf: 0.10% or less, and Bi: 0.200% or less.

3. The steel sheet according to the above 1, or 2., wherein the steel sheet has a coated or plated layer on a surface.

4. A member comprising the steel sheet according to any one of the above 1. to 3.

5. An automotive frame structural part or an automotive reinforcement part comprising the member according to the above 4.

6. A method of producing a steel sheet, comprising:
preparing a steel slab having the chemical composition according to the above 1, or 2.,
subjecting the steel slab to a hot rolling process in which rough rolling is performed under conditions that the number of passes in a temperature region of 1000° C. or higher is 4 or more, a rolling reduction ratio per pass is 15% or more, and an average strain rate is in a range of 9×10⁻⁴/s or more and 1×10⁻²/s or less, followed by finish rolling and then coiling to obtain a hot-rolled sheet, subjecting the hot-rolled sheet to a pickling and cold rolling process in which pickling and cold rolling are performed to obtain a cold-rolled sheet, then subjecting the cold-rolled sheet to annealing and then cooling the sheet to 150° C. or lower, and subsequently reheating the steel sheet, wherein
the annealing is performed under conditions that a heating temperature is 800° C. or higher, a dew point in the heating temperature region T1 of 800° C. or higher is −25° C. or higher, and the following Formula 1 is satisfied,

$$2.0 \leq K \leq 60.0 \qquad Formula 1$$

where

$$K = {\sum }_{t = 1}^{t E} D ( {T}_{t} ) \times 1 {0}^{6} , \qquad [ Math . 1 ]$$

$$D ( {T}_{t} ) = ( 0.07 + 0.06 [ \% C ] ) * exp ( - \frac{32000}{1.986 \times ( {T}_{t} + 273 )} )$$

where
[% C] represents a carbon content in the steel sheet, and
the time when the temperature of the cold-rolled sheet first reaches 800° C. during heating in the annealing is defined as t=0 (s), and t=tE (s) is the time when the annealing is completed and the temperature of the cold-rolled sheet again becomes 800° C., and Tₜ (° C.) is an average temperature of the cold-rolled sheet during time t: t−1 to t (s), during the cooling,
an average cooling rate v2 in a temperature region T2 of 600° C. or higher and 750° C. or lower is 1.0° C./s or higher and 15.0° C./s or lower,
an average cooling rate in a temperature region of 500° C. or higher and lower than 600° C. is higher than the v2,
a holding time in a temperature region T3 of 400° C. or higher and lower than 500° C. is 10 s or more and 150 s or less,
an average cooling rate v4 in a temperature region T4 of Ms−100° C. or higher and Ms ° C. or lower is 3.0° C./s or higher, and
the reheating is performed under conditions that the maximum arrival temperature X of the reheating and the holding time Y at X−10° C. or higher satisfy the following Formula (2)

$$8000 \leq ( 273 + X ) \times ( 20 + Log ( Y / 3600 ) ) \leq 12000 \qquad Formula ( 2 )$$

where the unit of the temperature X is ° C., and the unit of the holding time Y is second.

7. The method of producing a steel sheet according to the above 6., wherein coating or plating treatment is further performed during the cooling.

8. A method of producing a member, comprising subjecting the steel sheet according to any one of the above 1. to 3. to either or both of forming processing and joining processing to obtain a member.

### Advantageous Effect

According to the present disclosure, it is possible to provide a high-strength steel sheet that is excellent in all of member strength, stretch flangeability, bendability, and delayed fracture resistance under atmospheric corrosion conditions in the coated state.

In addition, it is possible to provide a member containing the steel sheet.

Furthermore, according to the present disclosure, it is possible to provide methods of producing the steel sheet and the member.

In addition, according to the present disclosure, it is possible to provide an automotive frame structural part or an automotive reinforcement part using the member.

### DETAILED DESCRIPTION

Hereinafter, the high-strength steel sheet of the present disclosure and a method of producing the same will be described in detail, divided into its chemical composition, microstructure, and production process.

First, the appropriate range of the chemical composition and the reasons for its limitations will be explained. In the following description, the term “%” representing the content of constituent elements in steel means “mass %” unless otherwise specified.

### [C: 0.090% or More and 0.390% or Less]

C is one of the important basic elements of steel. In the high-strength steel sheet of the present disclosure, it affects the area ratio of tempered martensite and the delayed fracture resistance at the ¼ thickness position.

If the C content is too low, the area ratio of tempered martensite at the ¼ thickness position decreases, making it difficult to achieve a tensile strength (TS) of 1180 MPa or higher. Therefore, the C content is set to 0.090% or more. The C content is preferably 0.115% or more, and more preferably 0.140% or more.

On the other hand, if the C content is too high, the strength of tempered martensite at the ¼ thickness position increases significantly, promoting crack propagation in delayed fracture testing, and lowering the delayed fracture resistance under atmospheric corrosion conditions in the coated state. Therefore, the C content is set to 0.390% or less. The C content is preferably 0.375% or less, and more preferably 0.360% or less.

### [Si: 0.01% or More and 2.00% or Less]

Si increases the strength of the steel sheet by suppressing the precipitation of cementite in tempered martensite and in fresh martensite and by solid solution strengthening. To obtain this effect, the Si content is set to 0.01% or more. The Si content is preferably 0.05% or more, and more preferably 0.10% or more.

On the other hand, if the Si content is too high, precipitation of carbides during bainitic transformation and martensitic transformation is excessively suppressed, the retained austenite at the ¼ thickness position increases excessively, and the hardness of deformation-induced martensite formed from the retained austenite during shearing significantly increases. As a result, the delayed fracture resistance under atmospheric corrosion conditions in the coated state is lowered. Additionally, the stretch flangeability is lowered. Therefore, the Si content is set to 2.00% or less. The Si content is preferably 1.75% or less, and more preferably 1.50% or less.

### [Mn: 2.00% or More and 4.00% or Less]

Mn is one of the important basic elements of steel, and particularly in the present disclosure, it greatly affects the area ratio of tempered martensite, the delayed fracture resistance, and the stretch flangeability.

If the Mn content is too low, the area ratio of tempered martensite decreases, making it difficult to achieve a tensile strength (TS) of 1180 MPa or higher. Therefore, the Mn content is set to 2.00% or more. The Mn content is preferably 2.20% or more, and more preferably 2.40% or more.

On the other hand, if the Mn content is too high, austenite is stabilized, the retained austenite at the ¼ thickness position increases excessively, and the hardness of deformation-induced martensite formed from the retained austenite during shearing significantly increases. As a result, the delayed fracture resistance under atmospheric corrosion conditions in the coated state is lowered. Additionally, the stretch flangeability is lowered. Therefore, the Mn content is set to 4.00% or less. The Mn content is preferably 3.70% or less, more preferably 3.50% or less, and even more preferably 3.30% or less.

### [P: 0.100% or Less]

P segregates at prior austenite grain boundaries, embrittling the grain boundaries and thereby reducing the ultimate deformability of the steel sheet, which in turn lowers bendability. Therefore, the P content needs to be 0.100% or less. The P content is preferably 0.070% or less. There is no specific lower limit for the P content, but since P is a solid-solution-strengthening element and increases the strength of the steel sheet, the P content is preferably 0.001% or more.

### [S: 0.0200% or Less]

S exists in the form of sulfides, which reduce the ultimate deformability of the steel sheet, thereby lowering bendability. Therefore, the S content needs to be 0.0200% or less. The S content is preferably 0.0050% or less. There is no specific lower limit for the S content, but the S content is preferably 0.0001% or more considering the restrictions on production technologies.

### [Al: 1.000% or Less]

Al sufficiently deoxidizes the steel and reduces inclusions. If the Al content is too high, a large amount of ferrite is generated, and delayed fracture cracks easily propagate at the interface between ferrite and tempered martensite or ferrite and fresh martensite, thereby lowering the delayed fracture resistance under atmospheric corrosion conditions in the coated state. Therefore, the Al content is set to 1.000% or less. The Al content is preferably 0.500% or less, and more preferably 0.100% or less.

On the other hand, to achieve stable deoxidation, the Al content is preferably 0.010% or more, more preferably 0.015% or more, and even more preferably 0.020% or more.

### [N: 0.0100% or Less]

N exists in the form of nitrides, which reduce the ultimate deformability of the steel sheet, thereby lowering bendability. Therefore, the N content is set to 0.0100% or less. The N content is preferably 0.0050% or less. There is no specific lower limit for the N content, but the N content is preferably 0.0001% or more considering the restrictions on production technologies.

### [O: 0.0100% or Less]

O exists in the form of oxides, which reduce the ultimate deformability of the steel sheet, thereby lowering bendability. Therefore, the O content is set to 0.0100% or less. The O content is preferably 0.0050% or less. There is no specific lower limit for the O content, but the O content is preferably 0.0001% or more considering the restrictions on production technologies.

The high-strength steel sheet according to the present disclosure has a chemical composition containing the above-described elements, with the balance consisting of Fe and inevitable impurities. Examples of the inevitable impurities include Zn, Pb, As, Ge, Sr, and Cs. These impurities are allowed to be contained in total at 0.100% or less.

In addition to the above-described chemical composition, the steel sheet according to the present disclosure may further contain, either singly or in combination, at least one element selected from the group consisting of: Ti: 0.200% or less, Nb: 0.200% or less, V: 0.200% or less, Ta: 0.10% or less, W: 0.10% or less, B: 0.0100% or less, Cr: 1.00% or less, Mo: 1.00% or less, Ni: 1.00% or less, Co: 0.010% or less, Cu: 1.00% or less, Sn: 0.200% or less, Sb: 0.200% or less, Ca: 0.0100% or less, Mg: 0.0100% or less, REM: 0.0100% or less, Zr: 0.100% or less, Te: 0.100% or less, Hf: 0.10% or less, and Bi: 0.200% or less.

When the contents of Ti, Nb, and V are each 0.200% or less, coarse precipitates and inclusions are not excessively generated, and the ultimate deformability of the steel sheet is not reduced, so the bendability is not lowered. Therefore, when these elements are contained, the contents of Ti, Nb, and V are preferably 0.200% or less, and more preferably 0.100% or less, respectively. On the other hand, there is no specific lower limit for the contents of Ti, Nb, and V. It should be noted that Ti, Nb, and V contribute to increasing the strength of the steel sheet by forming fine carbides, nitrides, or carbonitrides during hot rolling or continuous annealing. Therefore, the contents of Ti, Nb, and V are preferably 0.001% or more, respectively.

When the contents of Ta and W are each 0.10% or less, coarse precipitates and inclusions are not excessively generated, and the ultimate deformability of the steel sheet is not reduced, so the bendability is not lowered. Therefore, the contents of Ta and W are preferably 0.10% or less, and more preferably 0.08% or less, respectively. On the other hand, there is no specific lower limit for the contents of Ta and W. It should be noted that Ta and W contribute to increasing the strength of the steel sheet by forming fine carbides, nitrides, or carbonitrides during hot rolling or continuous annealing. Therefore, the contents of Ta and W are preferably 0.01% or more, respectively.

When the B content is 0.0100% or less, cracks are not generated inside the steel sheet during casting or hot rolling, and the ultimate deformability of the steel sheet is not reduced, so the bendability is not lowered. Therefore, the B content is preferably 0.0100% or less, and more preferably 0.0080% or less. On the other hand, there is no specific lower limit for the B content. It should be noted that B segregates at austenite grain boundaries during annealing and is an element that improves hardenability. Therefore, the B content is preferably 0.0003% or more.

When the contents of Cr, Mo, and Ni are each 1.00% or less, coarse precipitates and inclusions do not increase, and the ultimate deformability of the steel sheet is not reduced, so the bendability is not lowered. Therefore, the contents of Cr, Mo, and Ni are preferably 1.00% or less, and more preferably 0.80% or less, respectively. On the other hand, there is no specific lower limit for the contents of Cr, Mo, and Ni. It should be noted that Cr, Mo, and Ni are elements that improve hardenability. Therefore, the contents of Cr, Mo, and Ni are preferably 0.01% or more, respectively.

When the Co content is 0.010% or less, coarse precipitates and inclusions do not increase, and the ultimate deformability of the steel sheet is not reduced, so the bendability is not lowered. Therefore, the Co content is preferably 0.010% or less, and more preferably 0.008% or less. On the other hand, there is no specific lower limit for the Co content. It should be noted that Co is an element that improves hardenability. Therefore, the Co content is preferably 0.001% or more.

When the Cu content is 1.00% or less, coarse precipitates and inclusions do not increase, and the ultimate deformability of the steel sheet is not reduced, so the bendability is not lowered. Therefore, the Cu content is preferably 1.00% or less, and more preferably 0.80% or less. On the other hand, there is no specific lower limit for the Cu content. It should be noted that Cu is an element that improves hardenability. Therefore, the Cu content is preferably 0.01% or more.

When the Sn content is 0.200% or less, cracks are not generated inside the steel sheet during casting or hot rolling, and the ultimate deformability of the steel sheet is not reduced, so the bendability is not lowered. Therefore, the Sn content is preferably 0.200% or less, and more preferably 0.100% or less. On the other hand, there is no specific lower limit for the Sn content. It should be noted that Sn is an element that improves hardenability. Therefore, the Sn content is preferably 0.001% or more.

When the Sb content is 0.200% or less, coarse precipitates and inclusions do not increase, and the ultimate deformability of the steel sheet is not reduced, so the bendability is not lowered. Therefore, the Sb content is preferably 0.200% or less, and more preferably 0.100% or less. On the other hand, there is no specific lower limit for the Sb content. It should be noted that Sb is an element that controls the softening depth of the surface layer and enables strength adjustment. Therefore, the Sb content is preferably 0.001% or more.

When the contents of Ca, Mg, and REM are each 0.0100% or less, coarse precipitates and inclusions do not increase, and the ultimate deformability of the steel sheet is not reduced, so the bendability is not lowered. Therefore, the contents of Ca, Mg, and REM are preferably 0.0100% or less, and more preferably 0.0050% or less, respectively. On the other hand, there is no specific lower limit for the contents of Ca, Mg, and REM. It should be noted that Ca, Mg, and REM spheroidize nitrides and sulfides and are elements that improve the ultimate deformability of the steel sheet. Therefore, the contents of Ca, Mg, and REM are preferably 0.0005% or more, respectively.

When the contents of Zr and Te are each 0.100% or less, coarse precipitates and inclusions do not increase, and the ultimate deformability of the steel sheet is not reduced, so the bendability is not lowered. Therefore, the contents of Zr and Te are preferably 0.100% or less, and more preferably 0.080% or less, respectively. On the other hand, there is no specific lower limit for the contents of Zr and Te. It should be noted that Zr and Te spheroidize nitrides and sulfides and are elements that improve the ultimate deformability of the steel sheet. Therefore, the contents of Zr and Te are preferably 0.001% or more, respectively.

When the Hf content is 0.10% or less, coarse precipitates and inclusions do not increase, and the ultimate deformability of the steel sheet is not reduced, so the bendability is not lowered. Therefore, the Hf content is preferably 0.10% or less, and more preferably 0.08% or less. On the other hand, there is no specific lower limit for the Hf content. It should be noted that Hf spheroidizes nitrides and sulfides and is an element that improves the ultimate deformability of the steel sheet. Therefore, the Hf content is preferably 0.01% or more.

When the Bi content is 0.200% or less, coarse precipitates and inclusions do not increase, and the ultimate deformability of the steel sheet is not reduced, so the bendability is not lowered. Therefore, the Bi content is preferably 0.200% or less, and more preferably 0.100% or less. On the other hand, there is no specific lower limit for the Bi content. It should be noted that Bi is an element that alleviates segregation. Therefore, the Bi content is preferably 0.001% or more.

Even when the contents of Ti, Nb, V, Ta, W, B, Cr, Mo, Ni, Co, Cu, Sn, Sb, Ca, Mg, REM, Zr, Te, Hf, and Bi are less than the preferable lower limits described above, the effects of the present disclosure are not impaired. Therefore, in such cases, they are treated as inevitable impurities.

Next, the microstructure at the ¼ thickness position of the steel sheet according to the present disclosure will be described.

### [Area Ratio of Tempered Martensite: 75% or More]

By containing a certain minimum amount of tempered martensite in the microstructure, it is possible to achieve a tensile strength (TS) of 1180 MPa or higher. In addition, the yield ratio (YR) can be increased. Therefore, the area ratio of tempered martensite is set to 75% or more. The area ratio of tempered martensite is preferably 80% or more, and more preferably 85% or more. On the other hand, there is no specific upper limit for the area ratio of tempered martensite, and even when the area ratio of tempered martensite is 100%, the above-described effects can be obtained.

Tempered martensite is defined as martensite in which carbides are observed in SEM observation, as described later. The carbides include cementite (θ), epsilon (ε), eta (η), and chi (χ). Tempered martensite also includes lower bainite formed at or below the Ms point. The observation position of the tempered martensite is, as described later, the ¼ thickness position of the steel sheet.

### [Area Ratio of Fresh Martensite: 15% or Less]

If there is too much fresh martensite, the yield stress decreases, and the strength of the parts decreases. In addition, the hardness difference between microstructural constituents becomes large, leading to reduced stretch flangeability. Therefore, the total area ratio of fresh martensite is set to 15% or less. The total area ratio of fresh martensite is preferably 13% or less, and more preferably 10% or less. Even when the total area ratio of fresh martensite is 0%, the effects of the present disclosure can be obtained.

Fresh martensite is defined as martensite in which no carbides are observed in SEM observation, as described later. The observation position of the fresh martensite is, as described later, the ¼ thickness position of the steel sheet.

### [Total Area Ratio of Ferrite and Bainite: 15% or Less]

If ferrite and bainite are present in excessive amounts in the microstructure, the hardness difference between microstructural constituents becomes large, the propagation of delayed fracture cracks is accelerated, and the delayed fracture resistance under atmospheric corrosion conditions in the coated state is lowered. In addition, the stretch flangeability decreases due to the hardness difference between microstructural constituents. Therefore, the total area ratio of ferrite and bainite is set to 15% or less. The total area ratio of ferrite and bainite is preferably 13% or less, and more preferably 10% or less. Even when the total area ratio of ferrite and bainite is 0%, the effects of the present disclosure can be obtained.

Ferrite is soft BCC iron formed at high temperatures and includes allotriomorphic ferrite and idiomorphic ferrite.

Bainite is angular BCC iron formed at temperatures above the Ms point and containing fine carbides.

The observation position of ferrite and bainite is the ¼ thickness position of the steel sheet.

### [Area Ratio of Retained Austenite: 15% or Less]

If the retained austenite is excessive, a large amount of hard martensite is generated from the retained austenite during shearing. As a result, the hardness difference between microstructural constituents becomes large, the propagation of delayed fracture cracks is accelerated, and the delayed fracture resistance under atmospheric corrosion conditions in the coated state is lowered. In addition, the stretch flangeability decreases due to the hardness difference between microstructural constituents. Furthermore, when retained austenite yields, the yield strength (YS) decreases, and the strength of the parts deteriorates.

Therefore, the area ratio of retained austenite is set to 15% or less. The area ratio of retained austenite is preferably 10% or less.

On the other hand, there is no specific lower limit, and even when the area ratio of retained austenite is 0%, the effects of the present disclosure can be obtained.

In the present disclosure, the method of measuring the area ratio of retained austenite is as follows.

First, the steel sheet to be measured is ground so that the ¼ thickness position (a position corresponding to ¼ of the sheet thickness from the surface of the steel sheet in the depth direction) becomes the measurement surface, and then further polished by 0.1 mm by chemical polishing to obtain a sample. For the measurement surface of this sample, an X-ray diffractometer is used with a Co Kα radiation source to measure the integrated reflection intensities of the (200), (220), and (311) planes of fcc iron (austenite), and the (200), (211), and (220) planes of bcc iron, respectively. Subsequently, the intensity ratios of the integrated reflection intensities of the fcc iron planes to those of the bcc iron planes are obtained, and nine intensity ratios in total are calculated. In the present disclosure, the average value of these nine intensity ratios is defined as the volume fraction of retained austenite. Furthermore, in the present disclosure, this volume fraction of retained austenite is regarded as the area ratio of retained austenite.

### [Residual Microstructure]

The microstructure at the ¼ thickness position of the steel sheet of the present disclosure may include microstructures (residual microstructure) other than the above-described tempered martensite, fresh martensite, ferrite, bainite, and retained austenite. However, the area ratio of the residual microstructure is preferably 5% or less from the viewpoint of not impairing the effects of the present disclosure. Examples of the residual microstructure include pearlite, alloy carbonitrides precipitated in ferrite, and other known microstructures of steel sheets.

[Average Value [τq] of Plastic Deformation Initiation Stress τq: 2.50 GPa or More and 4.10 GPa or Less]

The plastic deformation initiation stress at the ¼ thickness position of the steel sheet is an important requirement in the present disclosure.

Here, the plastic deformation initiation stress refers to the value obtained at the initial stage of the load-displacement curve obtained by nanoindentation, as described later, and means the stress at which the local region transitions from the elastic region to the plastic region.

The plastic deformation initiation stress in the present disclosure corresponds to the stress associated with dislocation generation and release in the local region, and is completely different from the conventionally used properties such as the nano-hardness obtained by a nanoindentation test or the yield strength obtained by a tensile test.

We intensively studied the relationship between the plastic deformation initiation stress obtained by nanoindentation and the delayed fracture resistance under atmospheric corrosion conditions in the coated state.

As a result, it was found that when the average value [τq] of the plastic deformation initiation stress τq at the ¼ thickness position of the steel sheet is set to 2.50 GPa or more and 4.10 GPa or less, the delayed fracture resistance under atmospheric corrosion conditions in the coated state is improved.

This is because, by setting the average value [τq] of the plastic deformation initiation stress τq to an appropriate value as described above, the generation and release of dislocations at the tip of delayed fracture cracks are optimized, thereby suppressing the propagation of delayed fracture cracks. As a result, it is estimated that the delayed fracture resistance under atmospheric corrosion conditions in the coated state is improved.

That is, when the average value [τq] of the plastic deformation initiation stress τq is less than 2.50 GPa, the generation and release of dislocations at the crack tip become significant, resulting in the promotion of vacancy or void formation, and thus propagation of delayed fracture cracks. Particularly in steel sheets having high strain dispersibility, the delayed fracture resistance under atmospheric corrosion conditions in the coated state decreases. Therefore, the average value [τq] of the plastic deformation initiation stress τq is set to 2.50 GPa or more. Preferably, the average value [τq] of the plastic deformation initiation stress τq is 2.65 GPa or more. More preferably, the average value [τq] of the plastic deformation initiation stress τq is 2.80 GPa or more.

On the other hand, when the average value [τq] of the plastic deformation initiation stress τq exceeds 4.10 GPa, the generation and release of dislocations at the crack tip are suppressed, resulting in brittle propagation of delayed fracture cracks along grain boundaries. Consequently, particularly in steel sheets having a high yield ratio, the delayed fracture resistance under atmospheric corrosion conditions in the coated state decreases.

Therefore, the average value [τq] of the plastic deformation initiation stress τq needs to be 4.10 GPa or less. Preferably, the average value of the plastic deformation initiation stress τq is 3.90 GPa or less. More preferably, the average value [τq] of the plastic deformation initiation stress τq is 3.80 GPa or less.

### [Standard Deviation σq of Plastic Deformation Initiation Stress: 0.30 GPa or Less]

The standard deviation σq of plastic deformation initiation stress at the ¼ thickness position of the steel sheet is an important requirement in the present disclosure. By setting the standard deviation σq of plastic deformation initiation stress to 0.30 GPa or less, the delayed fracture resistance under atmospheric corrosion conditions in the coated state is improved, particularly in steel sheets having a high yield ratio. This is because, by setting the standard deviation σq to 0.30 GPa or less, variations in microscopic plastic deformation initiation stress are suppressed. That is, variations in the generation and release behavior of dislocations at the crack tip are suppressed, thereby preventing delayed fracture cracks from selectively propagating through weak portions of the microstructure. As a result, it is estimated that the delayed fracture resistance under atmospheric corrosion conditions in the coated state is improved.

When the standard deviation σq of plastic deformation initiation stress exceeds 0.30 GPa, variations in microscopic plastic deformation initiation stress become large, and delayed fracture cracks selectively propagate through weak portions of the microstructure. As a result, the delayed fracture resistance under atmospheric corrosion conditions in the coated state decreases, particularly in steel sheets having a high yield ratio. Therefore, the standard deviation σq of plastic deformation initiation stress needs to be 0.30 GPa or less. Preferably, the standard deviation σq of plastic deformation initiation stress is 0.26 GPa or less.

On the other hand, the smaller the standard deviation σq of plastic deformation initiation stress, the better, and it may be 0 GPa.

Next, the microstructure at a 10 μm position from the steel sheet surface will be described.

### [Area Ratio of Tempered Martensite: 40% or Less]

When tempered martensite is excessive in the microstructure at the 10 μm position from the steel sheet surface, the initiation points for bending cracks increase, and the bendability deteriorates. Furthermore, in tempered martensite present in the surface layer of the steel sheet, hydrogen penetration is promoted by corrosion occurring in the surface layer of the steel sheet directly beneath the coating, thereby making delayed fracture cracks more likely to occur and reducing the delayed fracture resistance under atmospheric corrosion conditions in the coated state

Therefore, in the present disclosure, the area ratio of tempered martensite in the microstructure at the 10 μm position from the steel sheet surface is set to 40% or less. The area ratio of tempered martensite is preferably 35% or less, and more preferably 30% or less. Even when the area ratio of tempered martensite is 0%, the effects of the present disclosure can be obtained.

Tempered martensite is defined as martensite in which carbides are observed in SEM observation, as described later. The carbides include cementite (θ), epsilon (ε), eta (η), and chi (χ).

The observation position of the tempered martensite is, as described later, the position 10 μm from the steel sheet surface.

### [Area Ratio of Pearlite: 15% or Less]

When pearlite is excessive in the microstructure at the 10 μm position from the steel sheet surface, the initiation points for bending cracks increase, and the bendability deteriorates. Furthermore, stress during bending is concentrated in pearlite present in the surface layer, making delayed fracture cracks more likely to occur and reducing the delayed fracture resistance under atmospheric corrosion conditions in the coated.

Therefore, in the present disclosure, the area ratio of pearlite in the microstructure at the 10 μm position from the steel sheet surface is set to 15% or less. The area ratio of pearlite is preferably 10% or less. Even when the area ratio of pearlite is 0%, the effects can be obtained.

The observation position of the pearlite is, as described later, the position 10 μm from the steel sheet surface.

### [Total Area Ratio of Ferrite and Bainite: 60% or More]

By setting the total area ratio of ferrite and bainite at the 10 μm position from the steel sheet surface to 60% or more, the bendability and the delayed fracture resistance under atmospheric corrosion conditions in the coated state are improved.

That is, by increasing the total area ratio of ferrite and bainite, which are soft phases, the initiation points of cracks during bending decrease, thereby improving the bendability.

Furthermore, since ferrite and bainite have fewer lattice defects and fewer hydrogen trapping sites than tempered martensite and fresh martensite, hydrogen penetration caused by corrosion occurring in the surface layer of the steel sheet directly beneath the coating is suppressed, making delayed fracture cracks less likely to occur. As a result, the delayed fracture resistance under atmospheric corrosion conditions in the coated state is improved.

Therefore, it is essential that the total area ratio of ferrite and bainite be 60% or more, preferably 65% or more, and more preferably 70% or more. On the other hand, there is no specific upper limit, and even when the total area ratio of ferrite and bainite is 100%, the above effects can be obtained.

Ferrite is soft BCC iron formed at high temperatures and includes allotriomorphic ferrite and idiomorphic ferrite.

Bainite is angular BCC iron formed at temperatures above the Ms point and containing fine carbides.

The observation position of the ferrite and bainite is the position 10 μm from the steel sheet surface.

### [Residual Microstructure]

The steel microstructure at the 10 μm position from the steel sheet surface may include microstructures (residual microstructure) other than the above-described tempered martensite, pearlite, ferrite, and bainite. However, the area ratio of the residual microstructure is preferably 5% or less from the viewpoint of not impairing the effects of the present disclosure. Examples of the residual microstructure include pearlite, alloy carbonitrides precipitated in ferrite, and other known microstructures of steel sheets.

The method of measuring the area ratios of tempered martensite, fresh martensite, pearlite, ferrite, and bainite at the ¼ thickness position of the steel sheet or at the 10 μm position from the steel sheet surface is as follows.

First, a sample is cut from the steel sheet so that the sheet thickness cross section parallel to the rolling direction (L cross section) becomes the observation plane. The observation plane of the sample is mirror-polished using diamond paste, then finish-polished using colloidal silica, and further etched using 1 vol % nital to reveal the microstructure.

Subsequently, the ¼ thickness position of the steel sheet or the position 10 μm from the steel sheet surface on the observation plane of the sample is observed at three fields each using a scanning electron microscope (SEM) at an acceleration voltage of 10 kV and a magnification of 3000×, thereby obtaining SEM images for three fields.

From the obtained SEM images, the area ratio of each microstructure is calculated using Adobe Photoshop (manufactured by Adobe Systems). Specifically, the area ratio of each microstructure is obtained as the value of the measured area of each microstructure divided by the observation area. The area ratios of each microstructure are calculated for the three fields, and the average value thereof is defined as the area ratio of each microstructure.

In the SEM images, tempered martensite is a microstructural region having a hierarchical structure with fine internal unevenness and containing fine carbides with white contrast. Fresh martensite is a microstructural region having a hierarchical structure with fine internal unevenness and not containing fine carbides with white contrast. Pearlite is a lamellar microstructural region consisting of gray ferrite and white cementite. Ferrite is a gray flat microstructural region without carbides. Bainite is a gray microstructural region containing fine carbides internally.

In this manner, tempered martensite, fresh martensite, pearlite, ferrite, and bainite can be distinguished from each other.

[When the Average Value of Plastic Deformation Initiation Stress τs Measured by the Nanoindentation Method is Defined as [τs], the Proportion of Measurement Points Having Values Less than 0.85×[τs] is 25.0% or Less]

The proportion of the measurement points defined by the average value of plastic deformation initiation stress τs measured at the position 10 μm from the steel sheet surface by the nanoindentation method is an important requirement in the present disclosure. That is, when the average value is defined as [τs], by setting the proportion of measurement points having values less than 0.85×[τs] to 25.0% or less, the delayed fracture resistance under atmospheric corrosion conditions in the coated state is improved, particularly in steel sheets having a high yield ratio. This is because microstructural regions with values less than 0.85×[τs] are regions where local dislocation generation and release are likely to occur, thereby serving as initiation points for delayed fracture cracks at the steel sheet surface.

As described above, by setting the proportion of measurement points having values less than 0.85×[τs] to 25.0% or less, the number of sites in the surface layer of bent portions where local dislocation generation and release occur can be reduced, thereby reducing initiation points for delayed fracture. As a result, the delayed fracture resistance under atmospheric corrosion conditions in the coated state is improved

Therefore, in the present disclosure, the proportion of measurement points having values less than 0.85×[τs] needs to be 25.0% or less. Preferably, the proportion of measurement points having values less than 0.85×[τs] is 20.0% or less. On the other hand, there is no specific lower limit, and even when the proportion of measurement points having values less than 0.85×[τs] is 0%, the above effects can be obtained.

In the present disclosure, the 10 μm position from the steel sheet surface means a position at a depth of 10 μm in the thickness direction from the steel sheet surface (the plane perpendicular to the thickness direction). Furthermore, both the ¼ thickness position and the 10 μm position from the steel sheet surface need to satisfy the above requirements at positions from at least one side of the steel sheet.

Next, the method of measuring plastic deformation initiation stress according to the nanoindentation method will be described

To prepare the measurement sample, a sample is cut so that the sheet thickness cross section parallel to the rolling direction of the steel sheet (L cross section) becomes the measurement surface. The measurement surface is mirror-polished using diamond paste, and then finish-polished using colloidal silica.

A nanoindentation tester equipped with a Berkovich indenter is used for the measurement of plastic deformation initiation stress. The measurement positions are set to the ¼ thickness position of the steel sheet or the 10 μm position from the steel sheet surface. The nanoindentation test is carried out under load control with a loading rate and unloading rate of 50 μN/s, a maximum load of 500 μN, and a data acquisition time interval of 5 ms. The load P (N) and the displacement h (nm) at each load are obtained. At each measurement position, 40 nanoindentation tests are performed. The spacing between indentations is set to 2 μm or more. Using the obtained load-displacement curves, the Hertz contact displacement h_{c} (nm) at each load P (N) is calculated by the Hertz contact equation indicated below as Formula (3).

$$\begin{matrix}[ Math . 2 ] & \\ {h}_{c} = {( \frac{3 P}{4 {E}_{r} {R}^{\frac{1}{2}}} )}^{\frac{2}{3}} \times {10}^{9} & Formula ( 3 )\end{matrix}$$

In Formula (3), h_{c} (nm) is the displacement assuming elastic deformation obtained by the Hertz contact formula; P (N) is the load; Eᵣ (Pa) is the composite Young's modulus; and R (m) is the curvature radius of the indenter tip. The value of Er is defined as the average composite Young's modulus (for 40 points) determined from the unloading curve in each measurement.

Since R (m) varies depending on the wear condition of the Berkovich indenter, it is determined by fitting the load-displacement curve in the elastic region using a standard sample such as fused silica.

At each load P (N), using h_{c} (nm) obtained from Formula (3) and the displacement h (nm) measured in the nanoindentation test, the minimum load Pₘᵢₙ (N) that satisfies the condition of the following Formula (4) is determined, and this Pₘᵢₙ (N) is defined as the plastic deformation initiation load.

$$\begin{matrix}[ Math . 3 ] & \\ h - {h}_{c} < 1. nm & Formula ( 4 )\end{matrix}$$

Furthermore, plastic deformation initiation stress t (GPa) is calculated from the plastic deformation initiation load using the following Formula (5).

$$\begin{matrix}[ Math . 4 ] & \\ τ = 0.194 {( \frac{{E}_{r}}{R} )}^{\frac{2}{3}} P {min}^{\frac{1}{3}} \times 1 {0}^{- 9} & Formula ( 5 )\end{matrix}$$

Using Formulas (3), (4), and (5), plastic deformation initiation stress t (GPa) is obtained for 40 points, and their average value is calculated.

The average value of plastic deformation initiation stress at the ¼ thickness position is defined as [τq], and the average value of plastic deformation initiation stress at the 10 μm position from the steel sheet surface is defined as [τs]. In addition, a histogram is prepared using the 40 values of plastic deformation initiation stress at the ¼ thickness position, and the standard deviation σq is determined. Furthermore, with the 40 values of plastic deformation initiation stress at the 10 μm position from the steel sheet surface, the proportion of measurement points having values less than 0.85×[τs] can be determined.

The thickness of the high-strength steel sheet of the present disclosure is not particularly limited. The thickness is usually preferably 0.3 mm or more. The thickness is usually preferably 2.8 mm or less.

### [Coated or Plated Layer]

The steel sheet according to the present disclosure may have a coated or plated layer on its surface. The coated or plated layer is formed by the coating or plating treatment described later. The type of coating or plating is not particularly limited, and examples include hot dip coating and electroplating. Examples of the coated or plated layer include a galvanized layer (zinc coated or plated layer) and an aluminum coated or plated layer. The coated or plated layer is preferably a galvanized layer. The galvanized layer may contain elements such as Al and Mg. The coated or plated layer may also be an alloy-coated or alloy-plated layer.

The composition of the coated or plated layer is not particularly limited and may be a general composition.

For example, when the coated or plated layer is a hot-dip galvanized layer or a galvannealed layer, the following composition is typical. That is, it contains Fe: 20 mass % or less, Al: 0.001 mass % to 1.0 mass %, and further contains at least one selected from the group consisting of Pb, Sb, Si, Sn, Mg, Mn, Ni, Cr, Co, Ca, Cu, Li, Ti, Be, Bi, and REM in a total amount of 0 mass % or more and 3.5 mass % or less, with the balance consisting of Zn and inevitable impurities.

When the coated or plated layer is a hot-dip galvanized layer, the coating weight per side is preferably 20 g/m² or more. On the other hand, the coating weight per side is preferably 80 g/m² or less. Furthermore, a galvannealed layer obtained by alloying such a coating weight of hot-dip galvanized layer may also be used.

In addition, when the coated or plated layer is a hot-dip galvanized layer, the Fe content in the coated or plated layer is preferably less than 7 mass %. When the coated or plated layer is a galvannealed layer, the Fe content in the coated or plated layer is preferably 7 mass % or more. On the other hand, the Fe content in the coated or plated layer is preferably 20 mass % or less, and more preferably 15 mass % or less.

### [Member]

A member according to one embodiment of the present disclosure will be described below.

The member according to the present disclosure is made using the steel sheet according to the embodiment of the present disclosure described above. The member is, for example, obtained by forming or joining the steel sheet according to the embodiment described above into a desired shape.

The member according to one embodiment of the present disclosure is preferably a member for an automotive frame structural part or a member for an automotive reinforcement part. The steel sheet according to the present disclosure is a high-strength steel sheet that is excellent in all of member strength, stretch flangeability, bendability, and delayed fracture resistance under atmospheric corrosion conditions in the coated state. Therefore, the member according to the present disclosure can be particularly suitably used for all types of members for automotive frame structural parts or members for automotive reinforcement parts.

### [Part]

A part according to one embodiment of the present disclosure will be described below.

The part according to the present disclosure is made using the member of the present disclosure described above. The part according to one embodiment of the present disclosure is preferably an automotive frame structural part or an automotive reinforcement part. The member of the present disclosure described above is excellent in all of member strength, stretch flangeability, bendability, and delayed fracture resistance under atmospheric corrosion conditions in the coated state. Accordingly, the part according to one embodiment of the present disclosure, which is made using such a member, can be particularly suitably used for all types of automotive frame structural parts or automotive reinforcement parts.

### [Method of Producing Steel Sheet]

Next, a method of producing the steel sheet according to the present disclosure will be described.

First, a steel material having the above-described chemical composition is melted to produce a steel slab. The method of melting steel to form a steel slab is not particularly limited, and known melting methods using a converter, an electric furnace, or the like may be adopted. To prevent macrosegregation, it is preferable to produce the steel slab by a continuous casting method, but it may also be produced by other methods such as an ingot casting method or a thin-slab casting method.

The steel sheet of the present disclosure includes a cold-rolled steel sheet produced by performing hot rolling, pickling, cold rolling, and annealing, as well as a steel sheet obtained by applying a coated or plated layer to the cold-rolled steel sheet.

Subsequently, the steel slab is hot-rolled to form a hot-rolled sheet. In one example, the steel slab is once cooled to room temperature and then reheated for hot rolling (rough rolling and finish rolling). Alternatively, the produced steel slab may be charged into a heating furnace without cooling to room temperature while still in a warm state, or may be subjected to rough rolling immediately after slight heat retention.

### <Rough Rolling>

By rough rolling the steel slab under the following conditions, a rough-rolled sheet is obtained.

The heating temperature of the steel slab (slab heating temperature) is preferably 1100° C. or higher from the viewpoint of dissolving carbides and reducing rolling load. On the other hand, to prevent an increase in scale loss, the slab heating temperature is preferably 1300° C. or lower. The slab heating temperature is based on the surface temperature of the steel slab. Next, rough rolling is performed on the steel slab that has been heated to the slab heating temperature under the following conditions.

### [Number of Passes in the Temperature Region of 1000° C. Or Higher: 4 Passes or More]

By setting the number of passes in the temperature region of 1000° C. or higher to 4 or more, the proportion of measurement points having values less than 0.85×[τs] can be reduced. Increasing the number of passes in the temperature region of 1000° C. or higher increases the number of strain introductions near the surface, thereby promoting and homogenizing the diffusion of substitutional solid solution elements such as Si and Mn. When the number of passes in the temperature region of 1000° C. or higher is less than 4, regions depleted of Si and Mn appear at the steel sheet surface, the frictional force inside the crystals decreases, and the number of measurement points with significantly reduced plastic deformation initiation stress increases. Therefore, the number of passes in the temperature region of 1000° C. or higher needs to be 4 or more.

### [Rolling Reduction Ration Per Pass: 15% or More]

By setting the rolling reduction ratio per pass to 15% or more, the standard deviation σq of plastic deformation initiation stress can be reduced. A rolling reduction ratio per pass of 15% or more promotes dynamic recrystallization of γ grains inside the steel sheet, thereby homogenizing grain size and elemental concentration distribution. When the rolling reduction ratio per pass is less than 15%, dynamic recrystallization of γ grains is not sufficiently promoted in some regions, resulting in uneven grain size and elemental concentration distribution, which increases variations in plastic deformation initiation stress in the final microstructure and raises the standard deviation σq of plastic deformation initiation stress. Therefore, the rolling reduction ratio per pass needs to be 15% or more.

[Average Strain Rate: 9×10⁻⁴/s or More and 1×10⁻²/s or Less]

By setting the average strain rate during rough rolling to a range of 9×10⁻⁴/s or more and 1×10⁻²/s or less, the standard deviation σq of plastic deformation initiation stress can be reduced. The average strain rate during rough rolling is defined as the rolling ratio ε (−) from the first mill to the last mill in rough rolling divided by the time t_{R} (s) required from the start of rolling in the first mill to the completion of rolling in the last mill in rough rolling (ε/t_{R}).

When the average strain rate during rough rolling exceeds 1×10⁻²/s, diffusion of solute atoms such as Si and Mn during plastic deformation and dynamic recrystallization of austenite grains becomes insufficient, leading to the appearance of regions depleted in Si and Mn and regions enriched in Si and Mn inside the steel sheet. Differences in frictional force inside the crystals occur between these regions, thereby increasing variations in plastic deformation initiation stress and raising the standard deviation σq of plastic deformation initiation stress.

On the other hand, when the average strain rate during rough rolling is less than 9×10⁻⁴/s, dynamic recovery of dislocations in austenite grains is promoted. As a result, the dislocation density decreases, pipe diffusion of solute atoms such as Si and Mn along dislocations is suppressed, diffusion of such solute atoms becomes insufficient, and regions depleted in Si and Mn and regions enriched in Si and Mn appear inside the steel sheet. Differences in frictional force inside the crystals occur between these regions, thereby increasing variations in plastic deformation initiation stress and raising the standard deviation σq of plastic deformation initiation stress.

Therefore, the average strain rate is set to a range of 9×10⁻⁴/s or more and 1×10⁻²/s or less. Preferably, the average strain rate is 1×10⁻³/s or more. On the other hand, the average strain rate is preferably 9×10⁻³/s or less.

### <Finish Rolling>

Subsequently, finish rolling is applied to the rough-rolled sheet to obtain a hot-rolled sheet (hot rolling process). The hot-rolled sheet is subjected to coiling as appropriate. When the slab heating temperature is set low, it is preferable to heat the rough-rolled sheet using a bar heater or the like prior to finish rolling to prevent troubles during hot rolling.

The temperature at which finish rolling is performed (finish rolling temperature) is preferably 700° C. or higher. This reduces rolling load. Furthermore, the rolling reduction ratio in the non-recrystallized state of austenite decreases, thereby suppressing the development of abnormally elongated structures in the rolling direction, and thus a steel sheet with excellent workability can be obtained.

The finish rolling may be performed continuously by joining rough-rolled sheets to each other. Alternatively, the rough-rolled sheet may be once coiled prior to finish rolling.

To reduce rolling load, part or all of the finish rolling may be carried out as lubrication rolling. Lubrication rolling is also preferable from the viewpoint of homogenizing the shape and material properties of the steel sheet. The frictional coefficient during lubrication rolling is preferably 0.10 or more. On the other hand, it is preferably 0.25 or less.

From the viewpoint of improving sheet passability during subsequent cold rolling and annealing, the coiling temperature after hot rolling is preferably 300° C. or higher. On the other hand, it is preferably 700° C. or lower.

Subsequently, the hot-rolled sheet obtained by hot rolling is subjected to pickling as appropriate. Pickling removes oxides from the surface of the hot-rolled sheet, thereby enabling the high-strength steel sheet as a final product to exhibit excellent chemical convertibility and high-quality coated or plated layers. The pickling may be performed once or divided into multiple stages.

After pickling, the hot-rolled sheet may optionally be subjected to softening heat treatment, and then cold rolling is performed to obtain a cold-rolled sheet. The conditions of the cold rolling are not particularly limited and may follow conventional methods. However, the cumulative rolling reduction ratio in cold rolling is preferably in the range of 20% to 75%. The number of rolling passes and the rolling reduction ratio per pass in the cold rolling are not particularly limited and may be in accordance with conventional methods

The cold-rolled sheet thus obtained is subsequently subjected to annealing, followed by cooling to 150° C. or lower, and then reheated, as described below.

### <Annealing>

### [Heating Temperature: 800° C. Or Higher]

When the heating temperature in the annealing process is too low, reverse transformation into austenite does not sufficiently proceed, resulting in an increased area ratio of ferrite at the ¼ thickness position of the steel sheet, thereby decreasing the area ratio of tempered martensite at the ¼ thickness position of the steel sheet. Therefore, the heating temperature is set to 800° C. or higher. The heating temperature is preferably 830° C. or higher. On the other hand, although the upper limit of the heating temperature is not particularly limited, the heating temperature is preferably 1000° C. or lower from the viewpoint of workability and preventing damage to the furnace. The heating temperature is based on the surface of the steel sheet.

### [Dew Point: −25° C. Or Higher]

When the dew point of the atmosphere in a heating temperature region T1 of 800° C. or higher during the annealing process is too low, decarburization does not sufficiently proceed at the surface, and the total area ratio of ferrite and bainite at the 10 μm position from the steel sheet surface becomes excessively low. In addition, when the dew point is too low, the decarburization distribution at the 10 μm position from the steel sheet surface becomes non-uniform, resulting in the appearance of regions having low plastic deformation initiation stress, and the proportion of measurement points having values less than 0.85×[τs] at the position 10 μm from the steel sheet surface increases. Therefore, the dew point is set to −25° C. or higher. The dew point is preferably −20° C. or higher. On the other hand, although the upper limit of the dew point is not particularly limited, the dew point is preferably +15° C. or lower from the viewpoint of workability and preventing damage to the furnace.

### [Annealing is Performed Under Conditions Satisfying Formula 1]

$$2. \leq K \leq 60. \qquad Formula 1$$

Here, K (mm²) in Formula 1 is defined by the following expression:

$$\begin{matrix}[ Math . 5 ] \\ K = {\sum }_{t = 1}^{tE} D ( {T}_{t} ) \times {10}^{6} ,\end{matrix}$$

$$D ( {T}_{t} ) = ( 0.07 + 0.06 [ \% C ] ) * exp ( - \frac{32000}{1.986 \times ( {T}_{t} + 273 )} )$$

In Formula 1, the time when the temperature of the cold-rolled sheet first reaches 800° C. during heating in the annealing process is defined as t=0 (s), and t=tE (s) is the time when the annealing is completed and the temperature of the cold-rolled sheet again becomes 800° C.

Tₜ (° C.) is the average temperature of the cold-rolled sheet during time t: t−1 to t (s).

Further, [% C] represents the carbon content in the steel sheet.

In the steel sheet that has reached 800° C. in the annealing process, reverse transformation into austenite is completed at the ¼ thickness position of the steel sheet, and diffusion alleviates microsegregation and causes grain growth. Meanwhile, at the steel sheet surface, decarburization occurs in which C is removed from the surface. These phenomena are defined as parameter K, which is a parameter based on the diffusion behavior of C in the austenite region.

As described above, the parameter K is calculated from the C content in the steel sheet, the temperature during the annealing process, and the time. By appropriately controlling the value of the parameter K as described above, it is possible to control the standard deviation σq of plastic deformation initiation stress at the ¼ thickness position of the steel sheet, the total area ratio of ferrite and bainite at the 10 μm position from the steel sheet surface, and the proportion of measurement points having values less than 0.85×[τs] within predetermined ranges.

That is, if K (mm²) is too small, insufficient diffusion of solute atoms in austenite causes microsegregation to remain at the ¼ thickness position of the steel sheet, and the standard deviation σq of plastic deformation initiation stress at the ¼ thickness position of the steel sheet becomes excessively high. In addition, insufficient decarburization at the 10 μm position from the steel sheet surface leads to an excessively low total area ratio of ferrite and bainite at the 10 μm position from the steel sheet surface. Furthermore, insufficient diffusion of solute atoms in austenite at the steel sheet surface also causes microsegregation to remain, and the proportion of measurement points having values less than 0.85×[τs] at the 10 μm position from the steel sheet surface becomes excessively high. Therefore, K (mm²) is set to 2.0 or more. Preferably, K (mm²) is 3.0 or more, and more preferably 4.0 or more.

On the other hand, if K (mm²) is too large, excessive grain growth occurs in some of the austenite at the ¼ thickness position of the steel sheet, leading to coarse prior γ grains. As the prior γ grains become larger, the microscopic Ms point at the level of each prior γ grain increases, and regions undergoing martensitic transformation at higher temperatures locally appear. This results in structural non-uniformity, and the standard deviation σq of plastic deformation initiation stress becomes excessively high. Therefore, K (mm²) is set to 60.0 or less. Preferably, K (mm²) is 45.0 or less, and more preferably 30.0 or less.

The temperature history in the annealing process is not particularly limited, as long as the parameter K falls within the above range.

### [Average Cooling Rate v2 in a Temperature Region T2 of 600° C. Or Higher and 750° C. Or Lower: 1.0° C./s or Higher and 15.0° C./s or Lower]

The temperature region T2 of 600° C. or higher and 750° C. or lower is a temperature region in which ferrite transformation occurs at the ¼ thickness position of the steel sheet and at the 10 μm position from the steel sheet surface. If the average cooling rate v2 in the temperature region T2 is too low, excessive ferrite transformation occurs at the ¼ thickness position of the steel sheet, and the area ratio of ferrite at the ¼ thickness position of the steel sheet increases. Therefore, the average cooling rate v2 is set to 1.0° C./s or higher. The average cooling rate v2 is preferably 2.0°/s or higher.

On the other hand, if the average cooling rate v2 is too high, ferrite transformation is less likely to occur at the position 10 μm from the steel sheet surface, and the area ratio of ferrite at the 10 μm position from the steel sheet surface decreases. Therefore, the average cooling rate v2 is set to 15.0° C./s or lower. The average cooling rate v2 is preferably 13.0° C./s or lower.

[Average Cooling Rate in a Temperature Region of 500° C. Or Higher and Lower than 600° C.: Higher than v2]

The temperature region of 500° C. or higher and lower than 600° C. is a temperature region in which pearlite transformation may occur at the 10 μm position from the steel sheet surface. That is, if the average cooling rate in the temperature region of 500° C. or higher and lower than 600° C. is v2 or lower, pearlite transformation occurs with the ferrite/austenite interface serving as a nucleation site, and the area ratio of pearlite at the 10 μm position from the steel sheet surface excessively increases. Therefore, the average cooling rate in the temperature region of 500° C. or higher and lower than 600° C. is set to higher than v2. Preferably, it is set to higher than (v2+2° C./s). Although there is no specific upper limit for the average cooling rate in this temperature range, it is about 1000° C./s or lower due to equipment limitations.

[Holding Time in a Temperature Region T3 of 400° C. Or Higher and Lower than 500° C.: 10 s or More and 150 s or Less]

The temperature region T3 of 400° C. or higher and lower than 500° C. is a temperature region in which bainite transformation occurs at the ¼ thickness position of the steel sheet and at the 10 μm position from the steel sheet surface. If the holding time in the temperature region T3 is too short, bainite transformation is less likely to occur at the 10 μm position from the steel sheet surface, and the area ratio of bainite at the 10 μm position from the steel sheet surface decreases. Therefore, the holding time in the temperature region T3 is set to 10 s or more. The holding time in the temperature region T3 is preferably 15 s or more.

On the other hand, if the holding time in the temperature region T3 is too long, excessive bainite transformation occurs at the ¼ thickness position of the steel sheet, and the area ratio of bainite at the ¼ thickness position of the steel sheet increases. Therefore, the holding time in the temperature region T3 is set to 150 s or less. The holding time in the temperature region T3 is preferably 130 s or less.

### [Average Cooling Rate v4 in a Temperature Region T4 of Ms−100° C. Or Higher and Ms ° C. Or Lower: 3.0° C./s or Higher]

The temperature region T4 of Ms−100° C. or higher and Ms ° C. or lower is a temperature region in which martensitic transformation occurs and self-tempering of the generated martensite takes place, and in which carbon partitioning from martensite into untransformed austenite occurs. If the average cooling rate v4 in the temperature region T4 is too low, self-tempering of the generated martensite and carbon partitioning from martensite into untransformed austenite are excessively promoted, leading to structural non-uniformity and causing the standard deviation σq of plastic deformation initiation stress to become excessively large. Therefore, the average cooling rate v4 is set to 3.0° C./s or higher. The average cooling rate v4 is preferably 4.0° C./s or higher.

On the other hand, there is no specific upper limit for the average cooling rate v4. However, from the viewpoint of reducing equipment investment burden, it is preferably about 1000° C./s or lower.

The Ms point is determined by the following Formula 6.

$$Ms = 499 - 308 [ \% C ] - 10.8 [ \% Si ] - 32.4 [ \% Mn ] - 27 [ \% Cr ] - 10.8 [ \% Mo ] \qquad Formula 6$$

where [% M] represents the content of element M in the steel (mass %).

### [Cooling to 150° C. Or Lower]

By cooling the steel sheet that has cooled to the temperature range T4 to 150° C. or lower, martensitic transformation sufficiently proceeds. If the cooling completion temperature is higher than 150° C., the martensitic transformation is not completed, and tempering will not occur during subsequent reheating, resulting in an excessive amount of fresh martensite. Therefore, the cooling completion temperature is set to 150° C. or lower. The cooling completion temperature is preferably 100° C. or lower.

[Reheating is performed under conditions that the maximum arrival temperature X of the reheating and the holding time Y at X−10° C. or higher satisfy the following Formula (2)]

$$8000 \leq ( 273 + X ) \times ( 20 + Log ( Y / 3600 ) ) \leq 12000 \qquad Formula ( 2 )$$

Here, the unit of the temperature X is ° C., and the unit of the holding time Y is second.

As described above, by appropriately reheating the cold-rolled sheet after cooling to 150° C. or lower, precipitation of carbides and segregation of C onto dislocations occur in the generated tempered martensite.

Here, if the variable part of Formula (2), expressed by the maximum arrival temperature X of the reheating and the holding time Y in the temperature range not exceeding X but at least X−10° C., i.e., [(273+X)×(20+Log (Y/3600))], is too small, precipitation of carbides and segregation of C onto dislocations in the tempered martensite are insufficient, resulting in a decrease in YS and thus a decrease in member strength. In addition, the mobility of dislocations in the tempered martensite increases, and the average value [τq] of plastic deformation initiation stress τq decreases. Therefore, the variable part is set to 8000 or more. The variable part is preferably 8500 or more.

On the other hand, if the variable part is too large, excessive precipitation of carbides and segregation of C onto dislocations occur in the tempered martensite. Furthermore, recovery of dislocations occurs, resulting in a decrease in TS. In addition, dislocations in the tempered martensite are pinned, and the average value [τq] of plastic deformation initiation stress τq increases. Therefore, the variable part is set to 12000 or less. The variable part is preferably 11500 or less.

The cold-rolled sheet subjected to such heat treatment is then cooled to room temperature. Thus, a high-strength steel sheet (cold-rolled steel sheet) according to the present disclosure is obtained.

In the production method of the present disclosure, when the coating or plating treatment described later is performed, the resulting high-strength steel sheet is a coated or plated steel sheet having a coated or plated layer.

Moreover, as long as the heat treatment series in the production method of the present disclosure satisfies the thermal hysteresis conditions described above, other conditions are not particularly limited, and the devices for carrying out the heat treatment are not particularly limited, either.

### <Coating or Plating Treatment>

In the production method of the present disclosure, a coating or plating treatment may be applied to the cold-rolled sheet

Examples of the coating or plating treatment include hot-dip galvanizing treatment (a treatment forming a hot-dip galvanized layer), and galvannealing treatment (a treatment forming a galvannealed layer by performing alloying treatment after hot-dip galvanizing treatment). Furthermore, an electroplating treatment may also be performed to form an electroplated layer.

For example, when hot-dip galvanizing treatment is performed, it is preferable to immerse the cold-rolled sheet in a galvanizing bath and then adjust the coating weight of the coated layer by gas wiping or the like. The bath temperature of the galvanizing bath is not particularly limited. It is preferably 440° C. or higher. In addition, it is preferably 500° C. or lower. The Al content in the galvanizing bath is preferably 0.10 mass % or more. In addition, it is preferably 0.23 mass % or less.

Here, it is preferable that the galvanizing treatment be performed after holding in the temperature region T3 of 400° C. or higher and lower than 500° C. during the cooling process after the annealing.

Subsequently, when alloying treatment is performed, the treatment temperature is preferably 470° C. or higher to optimize the Zn—Fe alloying rate and productivity. On the other hand, to suitably suppress transformation of untransformed austenite into pearlite and to optimize the TS, the alloying treatment temperature is preferably 600° C. or lower, and more preferably 560° C. or lower. The reference temperature for the alloying treatment is 530° C.

Skin pass rolling may also be applied to the steel sheet cooled to room temperature. From the viewpoint of stabilizing the shape, the rolling reduction ratio in the skin pass rolling is preferably 0.01% or more. On the other hand, there is no specific upper limit for the rolling reduction ratio, but from the viewpoint of productivity, it is preferably 1.50% or less.

The skin pass rolling may be performed online or offline. The target rolling reduction ratio may be achieved in one pass, or in several passes. From the viewpoint of productivity, it is preferable that the above-described series of treatments such as annealing and coating or plating treatment be performed in a CAL (Continuous Annealing Line) or CGL (Continuous Galvanizing Line).

Production conditions other than those described above may follow conventional methods.

### [Method of Producing Member]

By applying either or both of forming processing and joining processing to the above-described high-strength steel sheet, a member according to the present disclosure can be produced. The forming processing and the joining processing may follow conventional methods.

In the methods of producing the steel sheet, member, and part according to the present disclosure, any matter not described in this specification may follow conventional methods.

### EXAMPLES

Examples will be described below to specifically explain the present disclosure. However, the present disclosure is not limited to the Examples described below.

### <Production of Steel Sheet>

Molten steel having the chemical composition listed in Table 1 below (the balance being Fe and inevitable impurities) was produced in a converter, and a steel slab was obtained by continuous casting.

TABLE 1

| Steel | | | | | | | | | | | | | | | | | |
|---|---|---|---|---|---|---|---|---|---|---|---|---|---|---|---|---|---|
| sample | Chemical composition [mass %] | | | | | | | | | | | | | | | | |
| ID | C | Si | Mn | P | S | Al | N | O | Ti | Nb | V | Ta | W | B | Cr | Mo | Ni |
| A | 0.211 | 0.73 | 2.71 | 0.006 | 0.0002 | 0.017 | 0.0042 | 0.0005 | — | — | — | — | — | — | — | — | — |
| B | 0.286 | 0.75 | 2.78 | 0.011 | 0.0004 | 0.029 | 0.0049 | 0.0005 | — | — | — | — | — | — | — | — | — |
| C | 0.304 | 0.78 | 2.87 | 0.006 | 0.0007 | 0.021 | 0.0039 | 0.0005 | — | — | — | — | — | — | — | — | — |
| D | 0.124 | 0.56 | 3.09 | 0.011 | 0.0007 | 0.036 | 0.0036 | 0.0005 | — | — | — | — | — | — | — | — | — |
| E | 0.387 | 0.74 | 2.73 | 0.011 | 0.0005 | 0.036 | 0.0026 | 0.0005 | — | — | — | — | — | — | — | — | — |
| F | 0.197 | 1.72 | 2.64 | 0.010 | 0.0005 | 0.032 | 0.0041 | 0.0004 | — | — | — | — | — | — | — | — | — |
| G | 0.210 | 0.71 | 2.14 | 0.009 | 0.0008 | 0.014 | 0.0032 | 0.0006 | — | — | — | — | — | — | — | — | — |
| H | 0.198 | 0.06 | 3.63 | 0.010 | 0.0005 | 0.034 | 0.0037 | 0.0007 | — | — | — | — | — | — | — | — | — |
| I | 0.088 | 1.04 | 2.76 | 0.007 | 0.0005 | 0.014 | 0.0033 | 0.0004 | — | — | — | — | — | — | — | — | — |
| J | 0.405 | 0.14 | 2.66 | 0.010 | 0.0005 | 0.024 | 0.0033 | 0.0009 | — | — | — | — | — | — | — | — | — |
| K | 0.204 | 2.08 | 3.12 | 0.006 | 0.0010 | 0.013 | 0.0032 | 0.0005 | — | — | — | — | — | — | — | — | — |
| L | 0.190 | 0.74 | 1.95 | 0.008 | 0.0005 | 0.034 | 0.0042 | 0.0003 | — | — | — | — | — | — | — | — | — |
| M | 0.179 | 0.73 | 4.12 | 0.009 | 0.0005 | 0.011 | 0.0033 | 0.0006 | — | — | — | — | — | — | — | — | — |
| N | 0.201 | 0.51 | 2.68 | 0.010 | 0.0010 | 0.012 | 0.0031 | 0.0003 | 0.088 | — | — | — | — | — | — | — | — |
| O | 0.214 | 0.98 | 3.12 | 0.011 | 0.0009 | 0.035 | 0.0037 | 0.0009 | — | 0.054 | — | — | — | — | — | — | — |
| P | 0.214 | 0.75 | 2.87 | 0.010 | 0.0005 | 0.021 | 0.0055 | 0.0009 | — | — | 0.170 | — | — | — | — | — | — |
| Q | 0.285 | 0.68 | 2.90 | 0.007 | 0.0009 | 0.017 | 0.0040 | 0.0008 | 0.024 | — | — | — | — | 0.0011 | — | — | — |
| R | 0.301 | 0.75 | 2.87 | 0.007 | 0.0007 | 0.027 | 0.0030 | 0.0008 | — | — | — | — | — | — | — | 0.51 | — |
| S | 0.221 | 0.52 | 2.49 | 0.011 | 0.0004 | 0.030 | 0.0039 | 0.0003 | — | — | — | — | — | — | 0.92 | — | — |
| T | 0.199 | 0.48 | 2.69 | 0.006 | 0.0052 | 0.033 | 0.0037 | 0.0023 | — | — | — | — | 0.15 | — | — | — | — |
| U | 0.281 | 0.80 | 2.74 | 0.010 | 0.0006 | 0.026 | 0.0041 | 0.0006 | — | — | — | — | — | — | — | — | 0.36 |
| V | 0.221 | 0.97 | 3.12 | 0.010 | 0.0004 | 0.030 | 0.0026 | 0.0006 | — | — | — | — | — | — | — | — | — |
| W | 0.142 | 1.02 | 2.80 | 0.008 | 0.0006 | 0.040 | 0.0041 | 0.0032 | — | — | — | — | — | — | — | — | — |
| X | 0.199 | 0.74 | 2.75 | 0.006 | 0.0007 | 0.031 | 0.0032 | 0.0006 | — | — | — | 0.05 | — | — | — | — | — |
| Y | 0.206 | 1.00 | 2.75 | 0.006 | 0.0021 | 0.025 | 0.0035 | 0.0006 | 0.021 | 0.019 | — | — | — | 0.0025 | — | — | — |
| Z | 0.310 | 0.76 | 2.74 | 0.011 | 0.0009 | 0.023 | 0.0035 | 0.0007 | — | — | — | — | — | — | — | — | — |
| AA | 0.135 | 1.00 | 3.07 | 0.041 | 0.0009 | 0.019 | 0.0034 | 0.0007 | — | — | — | — | — | — | — | — | — |
| AB | 0.289 | 0.55 | 2.76 | 0.011 | 0.0005 | 0.018 | 0.0034 | 0.0005 | — | — | — | — | — | — | — | — | — |
| AC | 0.210 | 1.02 | 2.64 | 0.008 | 0.0007 | 0.015 | 0.0031 | 0.0005 | — | — | — | — | — | — | — | — | — |
| AD | 0.282 | 0.56 | 2.57 | 0.009 | 0.0010 | 0.768 | 0.0030 | 0.0009 | — | — | — | — | — | — | — | — | — |
| AE | 0.213 | 0.71 | 2.78 | 0.008 | 0.0007 | 0.032 | 0.0027 | 0.0004 | — | — | — | — | — | — | — | — | — |
| AF | 0.212 | 0.99 | 2.74 | 0.009 | 0.0008 | 0.036 | 0.0038 | 0.0008 | — | — | — | — | — | — | — | — | — |
| AG | 0.295 | 1.01 | 2.98 | 0.006 | 0.0007 | 0.017 | 0.0031 | 0.0007 | — | — | — | — | — | — | — | — | — |
| AH | 0.207 | 0.52 | 2.69 | 0.005 | 0.0007 | 0.033 | 0.0038 | 0.0002 | 0.018 | 0.012 | — | — | — | 0.0019 | — | — | — |

| Steel | | | | | | | | | | | | | |
|---|---|---|---|---|---|---|---|---|---|---|---|---|---|
| sample | Chemical composition [mass %] | | | | | | | | | | | Ms | |
| ID | Co | Cu | Sn | Sb | Ca | Mg | REM | Zr | Te | Hf | Bi | (° C.) | Remarks |
| A | — | — | — | — | — | — | — | — | — | — | — | 338 | Presently disclosed steel |
| B | — | — | — | — | — | — | — | — | — | — | — | 313 | Presently disclosed steel |
| C | — | — | — | — | — | — | — | — | — | — | — | 304 | Presently disclosed steel |
| D | — | — | — | — | — | — | — | — | — | — | — | 355 | Presently disclosed steel |
| E | — | — | — | — | — | — | — | — | — | — | — | 283 | Presently disclosed steel |
| F | — | — | — | — | — | — | — | — | — | — | — | 334 | Presently disclosed steel |
| G | — | — | — | — | — | — | — | — | — | — | — | 357 | Presently disclosed steel |
| H | — | — | — | — | — | — | — | — | — | — | — | 320 | Presently disclosed steel |
| I | — | — | — | — | — | — | — | — | — | — | — | 371 | Comparative steel |
| J | — | — | — | — | — | — | — | — | — | — | — | 287 | Comparative steel |
| K | — | — | — | — | — | — | — | — | — | — | — | 313 | Comparative steel |
| L | — | — | — | — | — | — | — | — | — | — | — | 369 | Comparative steel |
| M | — | — | — | — | — | — | — | — | — | — | — | 302 | Comparative steel |
| N | — | — | — | — | — | — | — | — | — | — | — | 345 | Presently disclosed steel |
| O | — | — | — | — | — | — | — | — | — | — | — | 321 | Presently disclosed steel |
| P | — | — | — | — | — | — | — | — | — | — | — | 332 | Presently disclosed steel |
| Q | — | — | — | — | — | — | — | — | — | — | — | 310 | Presently disclosed steel |
| R | — | — | — | — | — | — | — | — | — | — | — | 300 | Presently disclosed steel |
| S | — | — | — | — | — | — | — | — | — | — | — | 320 | Presently disclosed steel |
| T | — | — | — | — | — | — | — | — | — | — | — | 345 | Presently disclosed steel |
| U | — | — | — | — | — | — | — | — | — | — | — | 315 | Presently disclosed steel |
| V | — | — | — | 0.088 | — | — | — | — | — | — | — | 319 | Presently disclosed steel |
| W | — | — | 0.045 | — | — | — | — | — | — | — | — | 354 | Presently disclosed steel |
| X | — | — | — | — | — | — | — | — | — | — | — | 341 | Presently disclosed steel |
| Y | — | — | — | — | — | — | — | — | — | — | — | 336 | Presently disclosed steel |
| Z | — | — | — | — | — | 0.0085 | — | — | — | — | — | 307 | Presently disclosed steel |
| AA | 0.009 | — | — | — | — | — | — | 0.095 | — | — | — | 347 | Presently disclosed steel |
| AB | — | — | — | — | — | — | 0.0078 | — | — | — | — | 315 | Presently disclosed steel |
| AC | — | 0.52 | — | — | — | — | — | — | — | — | — | 338 | Presently disclosed steel |
| AD | — | — | — | — | — | — | — | — | 0.083 | — | — | 323 | Presently disclosed steel |
| AE | — | — | — | — | — | — | — | — | — | 0.07 | — | 336 | Presently disclosed steel |
| AF | — | — | — | — | — | — | — | — | — | — | 0.077 | 334 | Presently disclosed steel |
| AG | — | — | — | — | 0.0091 | — | — | — | — | — | — | 301 | Presently disclosed steel |
| AH | — | 0.15 | — | 0.015 | — | — | — | — | — | — | — | 342 | Presently disclosed steel |

The underline indicates outside the scope of the present disclosure.

The obtained steel slab was subjected to hot rolling to obtain a hot-rolled sheet. Specifically, the steel slab was heated to 1250° C., rough rolled under the conditions listed in Table 2 below, namely the number of passes in the temperature range of 1000° C. or higher, the rolling reduction ratio per pass, and the average strain rate, then subjected to finish rolling at a finishing rolling temperature of 900° C., and then coiled at 500° C. After the coiling, the sheet was cooled to room temperature to obtain a hot-rolled sheet. The obtained hot-rolled sheet was subjected to pickling, then subjected to softening heat treatment at 500° C., and subsequently subjected to cold rolling at a rolling ratio of 50%. Thus, a cold-rolled sheet with a thickness of 1.4 mm was obtained. In Table 2, a mark “O” is given when the rolling reduction ratio in all passes during rough rolling was 15% or more, and a mark “x” is given when the rolling reduction ratio in at least one pass was less than 15%.

The obtained cold-rolled sheet was then subjected to annealing, cooling, and reheating treatments under the conditions listed in Table 2 below to obtain a high-strength steel sheet (cold-rolled steel sheet) according to the present disclosure or the like.

### <<Coating or Plating Treatment>>

Some of the cold-rolled sheets, after being held in the temperature region T3 of 400° C. or higher and lower than 500° C., were subjected hot-dip galvanizing treatment to form coated layers (hot-dip galvanized layers) on both surfaces, thereby obtaining hot-dip galvanized steel sheets (GI).

In the hot-dip galvanizing treatment, a hot-dip galvanizing bath (bath temperature: 470° C.) containing Al: 0.20 mass %, with the balance being Zn and inevitable impurities, was used. The coating weight of the hot-dip galvanized layer per side was about 45 g/m² to 72 g/m².

The composition of the formed hot-dip galvanized layer contained Fe: 0.1 mass % to 1.0 mass % and Al: 0.2 mass % to 1.0 mass %, with the balance being Zn and inevitable impurities.

Some other cold-rolled sheets, after being held in the temperature region T3 of 400° C. or higher and lower than 500° C., were subjected to galvannealing treatment to form coated layers (galvannealed layers) on both surfaces. Thus, galvannealed steel sheets (GA) were obtained.

In the hot-dip galvanizing treatment, a hot-dip galvanizing bath (bath temperature: 470° C.) containing Al: 0.14 mass %, with the balance being Zn and inevitable impurities, was used. The alloying treatment was set to 550° C. The coating weight of the galvannealed layer per side was about 45 g/m².

The composition of the formed galvannealed layer contained Fe: 7 mass % to 15 mass % and Al: 0.1 mass % to 1.0 mass %, with the balance being Zn and inevitable impurities.

In the following Table 2, “GI” is indicated in the column “Coating or plating type” when a hot-dip galvanized layer was formed, “GA” when a galvannealed layer was formed, and “CR” when no coated or plated layer was formed.

TABLE 2

| | | | | | | | | Cooling | |
|---|---|---|---|---|---|---|---|---|---|
| | | | | | | | | Average cooling | Average cooling |
| | | Rough rolling | | | | | | rate v2 in | rate in |
| | | Number of | | | | | | temperature | temperature |
| | | passes in | Rolling | | | | | region T2 of | region of |
| | | temperature range of | reduction | | Annealing | | | 600° C. or | 500° C. or |
| | Steel | 1000° C. | ratio per | Average | Heating | Dew | Parameter | higher and | higher and |
| | sample | or higher | pass of | strain rate | temperature | point | K | 750° C. or lower | lower than 600° C. |
| No. | ID | (pass) | 15% or more | (s⁻¹) | (° C.) | (° C.) | (mm²) | (° C./s) | (° C./s) |
| 1 | A | 5 | ∘ | 6.0.E−03 | 895 | −10 | 12.0 | 5.0 | 8.5 |
| 2 | A | 3 | ∘ | 6.0.E−03 | 895 | −10 | 12.0 | 5.0 | 8.5 |
| 3 | A | 5 | x | 6.0.E−03 | 895 | −10 | 12.0 | 5.0 | 8.5 |
| 4 | A | 5 | ∘ | 9.5.E−04 | 895 | −10 | 12.0 | 5.0 | 8.5 |
| 5 | A | 5 | ∘ | 7.0.E−04 | 895 | −10 | 12.0 | 5.0 | 8.5 |
| 6 | A | 5 | ∘ | 9.5.E−03 | 895 | −10 | 12.0 | 5.0 | 8.5 |
| 7 | A | 5 | ∘ | 2.0.E−02 | 895 | −10 | 12.0 | 5.0 | 8.5 |
| 8 | A | 5 | ∘ | 6.0.E−03 | 790 | −10 | 12.0 | 5.0 | 8.5 |
| 9 | A | 5 | ∘ | 6.0.E−03 | 895 | −30 | 12.0 | 5.0 | 8.5 |
| 10 | A | 5 | ∘ | 6.0.E−03 | 895 | −10 | 2.5 | 5.0 | 8.5 |
| 11 | A | 5 | ∘ | 6.0.E−03 | 895 | −10 | 1.5 | 5.0 | 8.5 |
| 12 | A | 5 | ∘ | 6.0.E−03 | 895 | −10 | 50.0 | 5.0 | 8.5 |
| 13 | A | 5 | ∘ | 6.0.E−03 | 895 | −10 | 70.0 | 5.0 | 8.5 |
| 14 | A | 5 | ∘ | 6.0.E−03 | 895 | −10 | 12.0 | 0.5 | 8.5 |
| 15 | A | 5 | ∘ | 6.0.E−03 | 895 | −10 | 12.0 | 17.0 | 8.5 |
| 16 | A | 5 | ∘ | 6.0.E−03 | 895 | −10 | 12.0 | 5.0 | 3.5 |
| 17 | A | 5 | ∘ | 6.0.E−03 | 895 | −10 | 12.0 | 5.0 | 8.5 |
| 18 | A | 5 | ∘ | 6.0.E−03 | 895 | −10 | 12.0 | 5.0 | 8.5 |
| 19 | A | 5 | ∘ | 6.0.E−03 | 895 | −10 | 12.0 | 5.0 | 8.5 |
| 20 | A | 5 | ∘ | 6.0.E−03 | 895 | −10 | 12.0 | 5.0 | 8.5 |
| 21 | A | 5 | ∘ | 6.0.E−03 | 895 | −10 | 12.0 | 5.0 | 8.5 |
| 22 | A | 5 | ∘ | 6.0.E−03 | 895 | −10 | 12.0 | 5.0 | 8.5 |
| 23 | A | 5 | ∘ | 6.0.E−03 | 895 | −10 | 12.0 | 5.0 | 8.5 |
| 24 | A | 5 | ∘ | 6.0.E−03 | 895 | −10 | 12.0 | 5.0 | 8.5 |
| 25 | A | 5 | ∘ | 6.0.E−03 | 895 | −10 | 12.0 | 5.0 | 8.5 |
| 26 | B | 5 | ∘ | 5.0.E−03 | 890 | −10 | 11.0 | 5.5 | 8.5 |
| 27 | B | 3 | ∘ | 5.0.E−03 | 890 | −10 | 11.0 | 5.5 | 8.5 |
| 28 | B | 5 | x | 5.0.E−03 | 890 | −10 | 11.0 | 5.5 | 8.5 |
| 29 | B | 5 | ∘ | 9.5.E−04 | 890 | −10 | 11.0 | 5.5 | 8.5 |
| 30 | B | 5 | ∘ | 7.0.E−04 | 890 | −10 | 11.0 | 5.5 | 8.5 |
| 31 | B | 5 | ∘ | 9.5.E−03 | 390 | −10 | 11.0 | 5.5 | 8.5 |
| 32 | B | 5 | ∘ | 2.0.E−02 | 890 | −10 | 11.0 | 5.5 | 8.5 |
| 33 | B | 5 | ∘ | 5.0.E−03 | 750 | −10 | 11.0 | 5.5 | 8.5 |
| 34 | B | 5 | ∘ | 5.0.E−03 | 890 | −30 | 11.0 | 5.5 | 8.5 |
| 35 | B | 5 | ∘ | 5.0.E−03 | 890 | −10 | 2.5 | 5.5 | 8.5 |
| 36 | B | 5 | ∘ | 5.0.E−03 | 890 | −10 | 1.5 | 5.5 | 8.5 |
| 37 | B | 5 | ∘ | 5.0.E−03 | 890 | −10 | 50.0 | 5.5 | 8.5 |
| 38 | B | 5 | ∘ | 5.0.E−03 | 890 | −10 | 70.0 | 5.5 | 8.5 |
| 39 | B | 5 | ∘ | 5.0.E−03 | 890 | −10 | 11.0 | 0.5 | 8.5 |
| 40 | B | 5 | ∘ | 5.0.E−03 | 890 | −10 | 11.0 | 17.0 | 8.5 |
| 41 | B | 5 | ∘ | 5.0.E−03 | 890 | −10 | 11.0 | 5.5 | 3.0 |
| 42 | B | 5 | ∘ | 5.0.E−03 | 890 | −10 | 11.0 | 5.5 | 8.5 |
| 43 | B | 5 | ∘ | 5.0.E−03 | 890 | −10 | 11.0 | 5.5 | 8.5 |
| 44 | B | 5 | ∘ | 5.0.E−03 | 890 | −10 | 11.0 | 5.5 | 8.5 |
| 45 | B | 5 | ∘ | 5.0.E−03 | 890 | −10 | 11.0 | 5.5 | 8.5 |
| 46 | B | 5 | ∘ | 5.0.E−03 | 890 | −10 | 11.0 | 5.5 | 8.5 |
| 47 | B | 5 | ∘ | 5.0.E−03 | 890 | −10 | 11.0 | 5.5 | 8.5 |
| 48 | B | 5 | ∘ | 5.0.E−03 | 890 | −10 | 11.0 | 5.5 | 8.5 |
| 49 | B | 5 | ∘ | 5.0.E−03 | 890 | −10 | 11.0 | 5.5 | 8.5 |
| 50 | B | 5 | ∘ | 5.0.E−03 | 890 | −10 | 11.0 | 5.5 | 8.5 |
| 51 | C | 5 | ∘ | 5.0.E−03 | 900 | −5 | 8.6 | 5.0 | 8.5 |
| 52 | D | 5 | ∘ | 5.0.E−03 | 875 | −10 | 15.0 | 5.0 | 8.5 |
| 53 | E | 5 | ∘ | 5.0.E−03 | 900 | −10 | 21.2 | 5.0 | 8.5 |
| 54 | F | 5 | ∘ | 5.0.E−03 | 850 | −10 | 12.0 | 5.0 | 8.5 |
| 55 | G | 5 | ∘ | 5.0.E−03 | 900 | −10 | 11.4 | 5.0 | 8.5 |
| 56 | H | 5 | ∘ | 5.0.E−03 | 875 | −10 | 12.3 | 4.5 | 7.5 |
| 57 | I | 5 | ∘ | 5.0.E−03 | 900 | −10 | 13.1 | 4.5 | 7.5 |
| 58 | J | 5 | ∘ | 5.0.E−03 | 900 | −10 | 12.1 | 4.5 | 7.5 |
| 59 | K | 5 | ∘ | 5.0.E−03 | 900 | −10 | 13.5 | 4.5 | 7.5 |
| 60 | L | 5 | ∘ | 5.0.E−03 | 900 | −10 | 11.0 | 5.5 | 8.5 |
| 61 | M | 5 | ∘ | 5.0.E−03 | 900 | −10 | 10.9 | 2.5 | 5.5 |
| 62 | N | 4 | ∘ | 5.0.E−03 | 900 | −10 | 18.4 | 5.5 | 8.5 |
| 63 | O | 5 | ∘ | 5.0.E−03 | 900 | −10 | 16.5 | 5.5 | 8.5 |
| 64 | P | 5 | ∘ | 5.0.E−03 | 860 | −10 | 12.0 | 5.5 | 8.5 |
| 65 | Q | 5 | ∘ | 5.0.E−03 | 900 | −10 | 8.6 | 5.5 | 8.5 |
| 66 | R | 4 | ∘ | 5.0.E−03 | 900 | −10 | 12.0 | 2.5 | 5.5 |
| 67 | S | 5 | ∘ | 5.0.E−03 | 900 | −10 | 21.2 | 5.5 | 8.5 |
| 68 | T | 5 | ∘ | 5.0.E−03 | 850 | −10 | 12.0 | 5.5 | 8.5 |
| 69 | U | 4 | ∘ | 5.0.E−03 | 900 | −10 | 8.6 | 5.5 | 8.5 |
| 70 | V | 5 | ∘ | 5.0.E−03 | 900 | −10 | 11.8 | 5.5 | 8.5 |
| 71 | W | 5 | ∘ | 5.0.E−03 | 900 | −10 | 12.3 | 5.5 | 8.5 |
| 72 | X | 5 | ∘ | 5.0.E−03 | 900 | −10 | 13.4 | 5.5 | 8.5 |
| 73 | Y | 5 | ∘ | 5.0.E−03 | 900 | −10 | 12.1 | 5.5 | 15.0 |
| 74 | Z | 5 | ∘ | 5.0.E−03 | 875 | −10 | 12.4 | 5.5 | 8.5 |
| 75 | AA | 5 | ∘ | 5.0.E−03 | 875 | −15 | 11.9 | 5.5 | 8.5 |
| 76 | AB | 5 | ∘ | 5.0.E−03 | 900 | −15 | 9.8 | 5.5 | 8.5 |
| 77 | AC | 5 | ∘ | 5.0.E−03 | 875 | −22 | 12.3 | 5.5 | 8.5 |
| 78 | AD | 5 | ∘ | 5.0.E−03 | 900 | −15 | 10.9 | 5.5 | 8.5 |
| 79 | AE | 5 | ∘ | 5.0.E−03 | 920 | −15 | 12.1 | 5.5 | 8.5 |
| 80 | AF | 5 | ∘ | 5.0.E−03 | 940 | −15 | 12.0 | 5.5 | 8.5 |
| 81 | AG | 5 | ∘ | 5.0.E−03 | 920 | −15 | 11.7 | 5.0 | 20.0 |
| 82 | AH | 5 | ∘ | 5.0.E−03 | 940 | −15 | 12.0 | 5.0 | 8.5 |

| | Cooling | | | | | |
|---|---|---|---|---|---|---|
| | | Average cooling | | | | |
| | Holding time | rate v4 in | | | | |
| | in temperature | temperature | | | | |
| | region T3 of | region T4 of | | Reheating | | |
| | 400° C. or | Ms-100° C. or | Cooling | Variable | Coating | |
| | higher and | higher and | completion | part of | or | |
| | lower than | Ms ° C. or lower | temperature | Formula | plating | |
| No. | 500° C. (s) | (° C./s) | (° C./s) | (2) | type | Remarks |
| 1 | 30 | 6.0 | 50 | 10441 | GA | Example |
| 2 | 30 | 6.0 | 50 | 10441 | GA | Comparative Example |
| 3 | 30 | 6.0 | 50 | 10441 | GA | Comparative Example |
| 1 | 30 | 6.0 | 50 | 10441 | GA | Example |
| 5 | 30 | 6.0 | 50 | 10441 | GA | Comparative Example |
| 6 | 30 | 6.0 | 50 | 10441 | GA | Example |
| 7 | 30 | 6.0 | 50 | 10441 | GA | Comparative Example |
| 8 | 30 | 6.0 | 50 | 10441 | GA | Comparative Example |
| 9 | 30 | 6.0 | 50 | 10441 | GA | Comparative Example |
| 10 | 30 | 6.0 | 50 | 10441 | GA | Example |
| 11 | 30 | 6.0 | 50 | 10441 | GA | Comparative Example |
| 12 | 30 | 6.0 | 50 | 10441 | GA | Example |
| 13 | 30 | 6.0 | 50 | 10441 | GA | Comparative Example |
| 14 | 30 | 6.0 | 50 | 10441 | GA | Comparative Example |
| 15 | 30 | 6.0 | 50 | 10441 | GA | Comparative Example |
| 16 | 30 | 6.0 | 50 | 10441 | GA | Comparative Example |
| 17 | 7 | 6.0 | 50 | 10441 | GA | Comparative Example |
| 18 | 160 | 6.0 | 50 | 10441 | GA | Comparative Example |
| 19 | 30 | 1.0 | 50 | 10441 | GA | Comparative Example |
| 20 | 30 | 6.0 | 80 | 10441 | GA | Example |
| 21 | 30 | 6.0 | 160 | 10441 | GA | Comparative Example |
| 22 | 30 | 6.0 | 50 | 8254 | GA | Example |
| 23 | 30 | 6.0 | 50 | 7708 | GA | Comparative Example |
| 24 | 30 | 6.0 | 50 | 11899 | GA | Example |
| 25 | 30 | 6.0 | 50 | 12446 | GA | Comparative Example |
| 26 | 30 | 6.0 | 50 | 10370 | GA | Example |
| 27 | 30 | 6.0 | 50 | 10370 | GA | Comparative Example |
| 28 | 30 | 6.0 | 50 | 10370 | GA | Comparative Example |
| 29 | 30 | 6.0 | 50 | 10370 | GA | Example |
| 30 | 30 | 6.0 | 50 | 10370 | GA | Comparative Example |
| 31 | 30 | 6.0 | 50 | 10370 | GA | Example |
| 32 | 30 | 6.0 | 50 | 10370 | GA | Comparative Example |
| 33 | 30 | 6.0 | 50 | 10370 | GA | Comparative Example |
| 34 | 30 | 6.0 | 50 | 10370 | GA | Comparative Example |
| 35 | 30 | 6.0 | 50 | 10370 | GA | Example |
| 36 | 30 | 6.0 | 50 | 10370 | GA | Comparative Example |
| 37 | 30 | 6.0 | 50 | 10370 | GA | Example |
| 38 | 30 | 6.0 | 50 | 10370 | GA | Comparative Example |
| 39 | 30 | 6.0 | 50 | 10370 | GA | Comparative Example |
| 40 | 30 | 6.0 | 50 | 10370 | GA | Comparative Example |
| 41 | 30 | 6.0 | 50 | 10370 | GA | Comparative Example |
| 42 | 7 | 6.0 | 50 | 10370 | GA | Comparative Example |
| 43 | 160 | 6.0 | 50 | 10370 | GA | Comparative Example |
| 44 | 30 | 2.0 | 50 | 10370 | GA | Comparative Example |
| 45 | 30 | 6.0 | 80 | 10370 | GA | Example |
| 46 | 30 | 6.0 | 160 | 10370 | GA | Comparative Example |
| 47 | 30 | 6.0 | 50 | 8198 | GA | Example |
| 48 | 30 | 6.0 | 50 | 7655 | GA | Comparative Example |
| 49 | 30 | 6.0 | 50 | 11817 | GA | Example |
| 50 | 30 | 6.0 | 50 | 12360 | GA | Comparative Example |
| 51 | 20 | 6.0 | 50 | 9530 | GA | Example |
| 52 | 20 | 15.0 | 50 | 9530 | GA | Example |
| 53 | 40 | 6.0 | 50 | 9530 | GA | Example |
| 54 | 100 | 6.0 | 50 | 9530 | GA | Example |
| 55 | 30 | 6.0 | 50 | 10441 | GA | Example |
| 56 | 30 | 6.0 | 50 | 10441 | GA | Example |
| 57 | 30 | 6.0 | 50 | 10441 | GA | Comparative Example |
| 58 | 30 | 6.0 | 50 | 10441 | GA | Comparative Example |
| 59 | 40 | 4.0 | 50 | 10441 | GA | Comparative Example |
| 60 | 30 | 6.0 | 50 | 10441 | GA | Comparative Example |
| 61 | 30 | 6.0 | 50 | 10441 | CR | Comparative Example |
| 62 | 30 | 6.0 | 140 | 10441 | GI | Example |
| 63 | 40 | 3.5 | 50 | 10441 | CR | Example |
| 64 | 30 | 6.0 | 50 | 10441 | GA | Example |
| 65 | 30 | 6.0 | 50 | 10441 | GI | Example |
| 66 | 30 | 6.0 | 50 | 10441 | CR | Example |
| 67 | 30 | 6.0 | 50 | 10441 | GI | Example |
| 68 | 30 | 6.0 | 100 | 10441 | GA | Example |
| 69 | 30 | 6.0 | 50 | 10441 | GA | Example |
| 70 | 130 | 4.0 | 50 | 10441 | GA | Example |
| 71 | 20 | 4.0 | 50 | 10441 | GA | Example |
| 72 | 30 | 21.0 | 50 | 10441 | GA | Example |
| 73 | 30 | 6.0 | 50 | 10441 | GA | Example |
| 74 | 30 | 6.0 | 50 | 10441 | GA | Example |
| 75 | 13 | 6.0 | 50 | 10441 | GA | Example |
| 76 | 15 | 6.0 | 50 | 10441 | GA | Example |
| 77 | 30 | 6.0 | 50 | 10441 | GA | Example |
| 78 | 100 | 4.0 | 50 | 10441 | CR | Example |
| 79 | 30 | 4.0 | 50 | 10441 | GA | Example |
| 80 | 30 | 6.0 | 50 | 10441 | GI | Example |
| 81 | 30 | 4.0 | 10 | 10441 | CR | Example |
| 82 | 30 | 6.0 | 25 | 10441 | GA | Example |

The underline indicates outside the scope of the present disclosure.
The underline indicates outside the scope of the present disclosure.

### <Observation of Steel Microstructure>

At the ¼ thickness position of the obtained steel sheet, the area ratios of tempered martensite, fresh martensite, ferrite, bainite, retained austenite, and the residual microstructure were measured in accordance with the above-described methods. Further, at the 10 μm position from the surface of the obtained steel sheet, the area ratios of tempered martensite, pearlite, ferrite, bainite, and the residual microstructure were measured in accordance with the above-described methods.

The measurement results are listed in Table 3 below.

### <Nanoindentation Test>

At the ¼ thickness position of the obtained steel sheet, the average value [τq] of plastic deformation initiation stress τq and the standard deviation σq of plastic deformation initiation stress were measured in accordance with the above-described methods. Further, at the 10 μm position from the surface of the obtained steel sheet, the proportion of measurement points having values less than 0.85×[τs], where the average value of plastic deformation initiation stress τs measured by the nanoindentation method is defined as [τs], was determined in accordance with the above-described method.

The measurement results are listed in Table 3 below.

### <Evaluation>

The obtained steel sheets were subjected to the tests described below to evaluate various properties. The results are also listed in Table 3 below.

### <<Tensile Test>>

The tensile test was conducted in accordance with JIS Z 2241:2021.

Specifically, a JIS No. 5 test piece was collected from the obtained steel sheet so that the longitudinal direction was perpendicular to the rolling direction of the steel sheet. Using the collected test piece, a tensile test was conducted at a crosshead speed of 1.67×10⁻¹ mm/s, and the yield strength (YS) [MPa] and tensile strength (TS) [MPa] were measured.

Further, from the yield strength and tensile strength, the yield ratio (YR) (=100× YS/TS) [%] was calculated.

In this example, when the tensile strength (TS) was 1180 MPa or higher, the steel sheet was judged to have high strength. When the yield ratio (YR) was more than 75%, the steel sheet was judged to have excellent member strength.

### <<Hole Expanding Test>>

The hole expanding test was conducted in accordance with JIS Z 2256. Specifically, the obtained steel sheet was sheared to collect a test piece of 100 mm×100 mm. A hole with a diameter of 10 mm was punched into the collected test piece with a clearance of 12.5%. Thereafter, using a die with an inner diameter of 75 mm, the test piece was held down with a blank holding force of 9 tons (88.26 kN), and a conical punch with an apex angle of 60° was pressed into the hole. The hole diameter Df [mm] at the crack initiation limit was measured. Taking the initial hole diameter as D0 [mm], the hole expansion ratio λ [%] was determined with the following Formula (7):

$$λ = \{ ( Df - D 0 ) / D 0 \} \times 100 \qquad Formula ( 7 )$$

In this example, when the hole expansion ratio (λ) was 30% or more, the steel sheet was judged to have excellent stretch flangeability.

### <<Bending Test>>

The bending test was conducted in accordance with JIS Z 2248:2022.

Specifically, a strip-shaped test piece with a width of 30 mm and a length of 100 mm was collected from the obtained steel sheet so that the direction parallel to the rolling direction of the steel sheet was the axial direction of the bending test. The end surface in the longitudinal direction of the test piece was ground to be a grinding-finished end surface.

Using the collected test piece, a 90° V-bending test was conducted under conditions of a pressing load of 100 kN and a pressing-holding time of 5 seconds. That is, a 90° V-bending test was conducted on five test pieces with an appropriate bending radius R. Next, the presence or absence of cracks at the ridge portion of the tip of the bending test piece was confirmed.

The presence or absence of cracks was confirmed by observing the ridge portion of the tip of the bending test piece with a digital microscope (RH-2000, manufactured by Hirox) at 40× magnification.

The minimum bending radius R at which no cracks occurred in any of the five test pieces was determined, and the value obtained by dividing this radius by the sheet thickness t (R/t) was defined as the limit bending radius. In this example, when the limit bending radius (R/t) was 5.0 or less, the steel sheet was judged to have excellent bendability.

### <<Delayed Fracture Resistance Under Atmospheric Corrosion Conditions in the Coated State>>

A delayed fracture test for confirming the delayed fracture resistance under atmospheric corrosion conditions in the coated state was conducted by subjecting a delayed fracture test piece, which had a sheared end surface and had been subjected to bending and stress loading, to chemical conversion electrodeposition coating, followed by a corrosion cycle test involving repeated wet and dry cycles.

Specifically, a strip-shaped test piece with a width of 30 mm and a length of 100 mm was collected from the obtained steel sheet so that the direction parallel to the rolling direction of the steel sheet was the axial direction of the bending test. The end surface in the longitudinal direction of the test piece was the sheared end surface (clearance: 15%, shear angle: 0) °.

The test piece was subjected to a 90° V-bending process so that R/t was 5.0, and then it was tightened with a bolt so that the load stress at the outer apex portion of the bend was 1000 MPa.

The test piece that had loaded the stress was subjected to a chemical conversion treatment using “Palbond” manufactured by Nihon Parkerizing Co., Ltd. under standard conditions (35° C., 120 s) by immersion, followed by electrodeposition coating and baking using electrodeposition paint “GT-100” manufactured by Kansai Paint Co., Ltd., thereby forming a coating film. The thickness of the electrodeposited coating film was set to 15 μm, and the thickness was measured and confirmed using a commercially available electromagnetic film thickness gauge.

The delayed fracture test piece of a bent portion having a sheared end surface in a coated state thus prepared were subjected to the corrosion cycle test.

The corrosion cycle test was conducted in a constant-temperature and constant-humidity chamber at 50° C., with one cycle consisting of drying (30% RH, 2 h), humidity transition (30%⇒90% RH, 2 h), wetting (90% RH, 2 h), and humidity transition (90%⇒30% RH, 2 h). In addition, twice a week, salt water was sprayed onto the surface of the delayed fracture test piece so that the coating weight of NaCl was 3 g/m².

This corrosion cycle test was conducted for 30 days, and when no crack was observed after 30 days, the delayed fracture resistance under atmospheric corrosion conditions in the coated state was evaluated as good and indicated with “O” in Table 3. Furthermore, when no crack was observed after 35 days, the delayed fracture resistance under atmospheric corrosion conditions in the coated state was evaluated as particularly good and indicated with “⊚” in Table 3. On the other hand, when a crack was observed before 30 days had elapsed, it was indicated with “x” in Table 3.

TABLE 3

| | | ¼ thickness position | | | | | | | |
|---|---|---|---|---|---|---|---|---|---|
| | | | | | | | Average | Standard | |
| | | | | Total | | | value [τq] | deviation | |
| | | | | area ratio | | | of plastic | σq of plastic | 10 μm position from steel sheet surface |
| | | Area ratio | Area ratio | of ferrite | Area ratio | | deformation | deformation | Area ratio |
| | Steel | of tempered | of fresh | and | of retained | | initiation | initiation | of tempered |
| | sample | martensite | martensite | bainite | austenite | Balance | stress | stress | martensite |
| No. | ID | (%) | (%) | (%) | (%) | (%) | τq (GPa) | (GPa) | (%) |
| 1 | A | 90 | 3 | 1 | 4 | 2 | 3.04 | 0.23 | 10 |
| 2 | A | 92 | 2 | 0 | 3 | 3 | 2.98 | 0.24 | 3 |
| 3 | A | 91 | 2 | 2 | 3 | 2 | 3.06 | 0.32 | 15 |
| 4 | A | 91 | 2 | 2 | 4 | 1 | 3.01 | 0.29 | 12 |
| 5 | A | 93 | 4 | 0 | 3 | 0 | 3.25 | 0.34 | 15 |
| 6 | A | 93 | 3 | 0 | 3 | 1 | 3.15 | 0.28 | 14 |
| 7 | A | 92 | 2 | 1 | 3 | 2 | 3.12 | 0.31 | 12 |
| 8 | A | 72 | 5 | 20 | 2 | 1 | 3.10 | 0.24 | 15 |
| 9 | A | 95 | 2 | 0 | 3 | 0 | 3.04 | 0.23 | 43 |
| 10 | A | 89 | 2 | 5 | 2 | 2 | 3.02 | 0.22 | 40 |
| 11 | A | 89 | 1 | 4 | 4 | 2 | 2.98 | 0.24 | 42 |
| 12 | A | 95 | 2 | 0 | 2 | 1 | 2.99 | 0.30 | 0 |
| 13 | A | 95 | 2 | 0 | 1 | 2 | 2.88 | 0.34 | 0 |
| 14 | A | 74 | 2 | 19 | 4 | 1 | 2.64 | 0.26 | 0 |
| 15 | A | 95 | 2 | 1 | 2 | 0 | 3.10 | 0.22 | 48 |
| 16 | A | 87 | 2 | 2 | 5 | 4 | 2.97 | 0.24 | 0 |
| 17 | A | 92 | 2 | 1 | 3 | 2 | 3.04 | 0.23 | 45 |
| 18 | A | 79 | 2 | 16 | 2 | 1 | 2.89 | 0.27 | 7 |
| 19 | A | 95 | 2 | 2 | 1 | 0 | 3.07 | 0.39 | 12 |
| 20 | A | 80 | 12 | 3 | 4 | 1 | 3.01 | 0.29 | 4 |
| 21 | A | 76 | 18 | 1 | 5 | 0 | 2.99 | 0.24 | 1 |
| 22 | A | 85 | 8 | 2 | 3 | 2 | 2.50 | 0.24 | 6 |
| 23 | A | 85 | 8 | 2 | 2 | 3 | 2.45 | 0.24 | 8 |
| 24 | A | 90 | 3 | 2 | 4 | 1 | 4.10 | 0.23 | 5 |
| 25 | A | 90 | 3 | 2 | 3 | 2 | 4.14 | 0.22 | 12 |
| 26 | B | 89 | 4 | 2 | 4 | 1 | 3.21 | 0.25 | 9 |
| 27 | B | 89 | 3 | 1 | 4 | 3 | 3.35 | 0.24 | 5 |
| 28 | B | 88 | 4 | 2 | 5 | 1 | 3.21 | 0.35 | 16 |
| 29 | B | 87 | 3 | 2 | 5 | 3 | 3.14 | 0.28 | 14 |
| 30 | B | 87 | 4 | 1 | 6 | 2 | 3.56 | 0.39 | 18 |
| 31 | B | 86 | 5 | 0 | 6 | 3 | 3.22 | 0.28 | 15 |
| 32 | B | 87 | 6 | 1 | 6 | 0 | 3.15 | 0.43 | 14 |
| 33 | B | 73 | 5 | 20 | 2 | 0 | 3.10 | 0.27 | 2 |
| 34 | B | 86 | 6 | 4 | 4 | 0 | 3.09 | 0.23 | 45 |
| 35 | B | 89 | 6 | 1 | 3 | 1 | 3.26 | 0.22 | 34 |
| 36 | B | 87 | 4 | 4 | 5 | 0 | 2.75 | 0.24 | 43 |
| 37 | B | 89 | 3 | 0 | 5 | 3 | 2.98 | 0.28 | 0 |
| 38 | B | 89 | 3 | 0 | 5 | 3 | 2.86 | 0.38 | 0 |
| 39 | B | 72 | 2 | 18 | 7 | 1 | 2.65 | 0.25 | 0 |
| 40 | B | 90 | 4 | 0 | 5 | 1 | 2.89 | 0.23 | 49 |
| 41 | B | 84 | 4 | 2 | 6 | 4 | 2.99 | 0.24 | 0 |
| 42 | B | 90 | 6 | 0 | 4 | 0 | 3.06 | 0.22 | 48 |
| 43 | B | 78 | 2 | 16 | 2 | 2 | 2.68 | 0.24 | 3 |
| 44 | B | 89 | 4 | 1 | 5 | 1 | 3.21 | 0.39 | 15 |
| 45 | B | 75 | 15 | 5 | 4 | 1 | 2.95 | 0.28 | 3 |
| 46 | B | 74 | 19 | 1 | 6 | 0 | 3.14 | 0.27 | 11 |
| 47 | B | 84 | 9 | 2 | 3 | 2 | 2.63 | 0.25 | 9 |
| 48 | B | 83 | 12 | 2 | 2 | 1 | 2.44 | 0.22 | 9 |
| 49 | B | 87 | 4 | 0 | 6 | 3 | 3.89 | 0.23 | 12 |
| 50 | B | 90 | 3 | 2 | 3 | 2 | 4.13 | 0.22 | 12 |
| 51 | C | 87 | 5 | 0 | 5 | 3 | 2.88 | 0.23 | 2 |
| 52 | D | 78 | 2 | 13 | 3 | 4 | 3.21 | 0.18 | 2 |
| 53 | E | 86 | 5 | 0 | 5 | 4 | 3.34 | 0.21 | 15 |
| 54 | F | 78 | 2 | 5 | 15 | 0 | 3.14 | 0.25 | 12 |
| 55 | G | 78 | 1 | 15 | 4 | 2 | 2.87 | 0.25 | 4 |
| 56 | H | 81 | 5 | 0 | 12 | 2 | 3.12 | 0.19 | 12 |
| 57 | I | 70 | 2 | 25 | 2 | 1 | 2.99 | 0.21 | 1 |
| 58 | J | 85 | 4 | 0 | 9 | 2 | 3.05 | 0.21 | 16 |
| 59 | K | 76 | 0 | 8 | 16 | 0 | 2.99 | 0.24 | 10 |
| 60 | L | 70 | 1 | 26 | 2 | 1 | 2.78 | 0.26 | 0 |
| 61 | M | 78 | 5 | 0 | 17 | 0 | 3.07 | 0.24 | 16 |
| 62 | N | 91 | 2 | 1 | 4 | 2 | 3.12 | 0.18 | 0 |
| 63 | O | 91 | 3 | 0 | 4 | 2 | 3.05 | 0.28 | 2 |
| 64 | P | 100 | 0 | 0 | 0 | 0 | 3.04 | 0.21 | 10 |
| 65 | Q | 86 | 5 | 1 | 6 | 2 | 3.20 | 0.17 | 12 |
| 66 | R | 87 | 6 | 0 | 5 | 2 | 3.31 | 0.23 | 12 |
| 67 | S | 95 | 2 | 0 | 3 | 0 | 3.04 | 0.23 | 0 |
| 68 | T | 82 | 4 | 10 | 3 | 1 | 2.86 | 0.24 | 10 |
| 69 | U | 87 | 5 | 0 | 7 | 1 | 3.14 | 0.21 | 15 |
| 70 | V | 80 | 4 | 11 | 4 | 1 | 2.98 | 0.21 | 0 |
| 71 | W | 95 | 2 | 1 | 2 | 0 | 3.21 | 0.21 | 0 |
| 72 | X | 96 | 0 | 0 | 2 | 2 | 3.04 | 0.14 | 0 |
| 73 | Y | 94 | 2 | 1 | 3 | 0 | 3.15 | 0.21 | 0 |
| 74 | Z | 88 | 4 | 0 | 6 | 2 | 3.04 | 0.22 | 12 |
| 75 | AA | 95 | 3 | 0 | 1 | 1 | 3.02 | 0.22 | 30 |
| 76 | AB | 87 | 6 | 0 | 5 | 2 | 3.12 | 0.21 | 14 |
| 77 | AC | 91 | 2 | 2 | 3 | 2 | 3.00 | 0.24 | 32 |
| 78 | AD | 87 | 6 | 0 | 5 | 2 | 3.01 | 0.23 | 12 |
| 79 | AE | 92 | 2 | 1 | 3 | 2 | 2.98 | 0.21 | 10 |
| 80 | AF | 93 | 1 | 2 | 3 | 1 | 2.98 | 0.19 | 5 |
| 81 | AG | 87 | 5 | 0 | 6 | 2 | 3.04 | 0.21 | 8 |
| 82 | AH | 95 | 0 | 0 | 3 | 2 | 3.04 | 0.24 | 0 |

| | 10 μm position from steel sheet surface | | | | | | | | | | |
|---|---|---|---|---|---|---|---|---|---|---|---|
| | | Total area | | Proportion of | | | | | | | |
| | | ratio | | measurement | | | | | | | |
| | | of ferrite | | points below | Properties | | | | | | |
| | Area ratio | and | | 0.85× | | | | | | Delayed | |
| | of pearlite | bainite | Balance | [τs] | YS | TS | YR | λ | | fracture | |
| No. | (%) | (%) | (%) | (%) | (MPa) | (MPa) | (%) | (%) | R/t | resistance | Remarks |
| 1 | 4 | 85 | 1 | 7.5 | 1284 | 1503 | 85 | 42 | 3.6 | ⊚ | Example |
| 2 | 5 | 92 | 0 | 32.5 | 1258 | 1498 | 84 | 38 | 4.3 | x | Comparative Example |
| 3 | 2 | 80 | 3 | 10.0 | 1232 | 1525 | 81 | 39 | 3.6 | x | Comparative Example |
| 4 | 2 | 85 | 1 | 12.5 | 1252 | 1521 | 82 | 36 | 3.6 | ∘ | Example |
| 5 | 2 | 80 | 3 | 10.0 | 1235 | 1498 | 82 | 38 | 3.6 | x | Comparative Example |
| 6 | 1 | 82 | 3 | 10.0 | 1247 | 1489 | 84 | 38 | 3.6 | ∘ | Example |
| 7 | 2 | 83 | 3 | 10.0 | 1287 | 1537 | 84 | 39 | 3.6 | x | Comparative Example |
| 8 | 2 | 80 | 3 | 10.0 | 956 | 1164 | 82 | 25 | 4.3 | x | Comparative Example |
| 9 | 3 | 50 | 4 | 32.5 | 1268 | 1502 | 84 | 38 | 5.7 | x | Comparative Example |
| 10 | 0 | 60 | 0 | 22.5 | 1245 | 1498 | 83 | 37 | 4.6 | ∘ | Example |
| 11 | 0 | 54 | 4 | 32.5 | 1235 | 1526 | 81 | 41 | 5.7 | x | Comparative Example |
| 12 | 0 | 98 | 2 | 7.5 | 1235 | 1472 | 84 | 47 | 3.2 | ∘ | Example |
| 13 | 0 | 98 | 2 | 7.5 | 1225 | 1465 | 84 | 37 | 3.2 | x | Comparative Example |
| 14 | 1 | 98 | 1 | 10.0 | 945 | 1165 | 81 | 26 | 3.9 | x | Comparative Example |
| 15 | 2 | 48 | 2 | 15.0 | 1201 | 1498 | 80 | 39 | 5.4 | x | Comparative Example |
| 16 | 17 | 80 | 3 | 15.0 | 1230 | 1490 | 83 | 42 | 5.4 | x | Comparative Example |
| 17 | 1 | 54 | 0 | 17.5 | 1268 | 1531 | 83 | 38 | 5.4 | x | Comparative Example |
| 18 | 2 | 88 | 3 | 7.5 | 1189 | 1458 | 82 | 25 | 4.3 | x | Comparative Example |
| 19 | 1 | 86 | 1 | 7.5 | 1212 | 1500 | 81 | 42 | 3.6 | x | Comparative Example |
| 20 | 0 | 94 | 2 | 7.5 | 1167 | 1520 | 77 | 34 | 3.9 | ⊚ | Example |
| 21 | 0 | 95 | 1 | 10.0 | 1101 | 1530 | 72 | 36 | 3.9 | ⊚ | Comparative Example |
| 22 | 1 | 92 | 1 | 10.0 | 1219 | 1600 | 76 | 35 | 3.9 | ∘ | Example |
| 23 | 2 | 88 | 2 | 7.5 | 1189 | 1621 | 73 | 34 | 3.9 | x | Comparative Example |
| 24 | 2 | 90 | 3 | 5.0 | 1098 | 1315 | 83 | 45 | 3.6 | ∘ | Example |
| 25 | 3 | 83 | 2 | 7.5 | 956 | 1156 | 83 | 45 | 3.6 | x | Comparative Example |
| 26 | 2 | 86 | 3 | 7.5 | 1364 | 1705 | 80 | 34 | 4.3 | ⊚ | Example |
| 27 | 1 | 92 | 2 | 32.5 | 1354 | 1707 | 79 | 35 | 4.6 | x | Comparative Example |
| 28 | 2 | 82 | 0 | 12.5 | 1348 | 1715 | 79 | 35 | 4.3 | x | Comparative Example |
| 29 | 0 | 85 | 1 | 12.5 | 1350 | 1700 | 79 | 35 | 4.3 | ∘ | Example |
| 30 | 0 | 80 | 2 | 7.5 | 1369 | 1723 | 79 | 36 | 4.3 | x | Comparative Example |
| 31 | 0 | 85 | 0 | 10.0 | 1388 | 1721 | 81 | 36 | 4.3 | ∘ | Example |
| 32 | 1 | 84 | 1 | 10.0 | 1347 | 1698 | 79 | 36 | 4.3 | x | Comparative Example |
| 33 | 1 | 97 | 0 | 7.5 | 1212 | 1489 | 81 | 25 | 4.3 | x | Comparative Example |
| 34 | 2 | 51 | 2 | 32.5 | 1369 | 1724 | 79 | 35 | 5.7 | x | Comparative Example |
| 35 | 1 | 63 | 2 | 22.5 | 1354 | 1702 | 80 | 35 | 4.6 | ∘ | Example |
| 36 | 2 | 54 | 1 | 32.5 | 1365 | 1712 | 80 | 36 | 5.7 | x | Comparative Example |
| 37 | 0 | 99 | 1 | 7.5 | 1342 | 1698 | 79 | 35 | 3.9 | ∘ | Example |
| 38 | 0 | 98 | 2 | 7.5 | 1305 | 1658 | 79 | 37 | 3.9 | x | Comparative Example |
| 39 | 0 | 99 | 1 | 7.5 | 1200 | 1425 | 84 | 24 | 3.9 | x | Comparative Example |
| 40 | 0 | 48 | 3 | 17.5 | 1365 | 1712 | 80 | 35 | 5.7 | x | Comparative Example |
| 41 | 18 | 81 | 1 | 17.5 | 1355 | 1709 | 79 | 36 | 5.7 | x | Comparative Example |
| 42 | 2 | 48 | 2 | 17.5 | 1345 | 1698 | 79 | 35 | 5.7 | x | Comparative Example |
| 43 | 2 | 92 | 3 | 5.0 | 1302 | 1700 | 77 | 23 | 4.3 | x | Comparative Example |
| 44 | 1 | 84 | 0 | 10.0 | 1345 | 1711 | 79 | 34 | 4.3 | x | Comparative Example |
| 45 | 1 | 94 | 2 | 7.5 | 1310 | 1725 | 76 | 34 | 4.3 | ⊚ | Example |
| 46 | 0 | 87 | 2 | 10.0 | 1260 | 1745 | 72 | 32 | 4.3 | ⊚ | Comparative Example |
| 47 | 1 | 90 | 0 | 10.0 | 1333 | 1762 | 76 | 33 | 4.3 | ∘ | Example |
| 48 | 2 | 88 | 1 | 7.5 | 1298 | 1782 | 73 | 33 | 4.3 | x | Comparative Example |
| 49 | 2 | 84 | 2 | 7.5 | 1250 | 1587 | 79 | 45 | 4.3 | ∘ | Example |
| 50 | 3 | 83 | 2 | 7.5 | 1235 | 1469 | 84 | 45 | 3.6 | x | Comparative Example |
| 51 | 0 | 97 | 1 | 5.0 | 1389 | 1752 | 79 | 33 | 4.3 | ⊚ | Example |
| 52 | 4 | 91 | 3 | 7.5 | 1021 | 1192 | 86 | 45 | 3.6 | ⊚ | Example |
| 53 | 0 | 84 | 1 | 12.5 | 1502 | 1805 | 83 | 32 | 4.3 | ∘ | Example |
| 54 | 0 | 84 | 4 | 12.5 | 1221 | 1589 | 77 | 31 | 3.6 | ⊚ | Example |
| 55 | 6 | 88 | 2 | 10.0 | 1021 | 1205 | 85 | 45 | 3.6 | ⊚ | Example |
| 56 | 0 | 86 | 2 | 7.5 | 1198 | 1562 | 77 | 32 | 4.3 | ∘ | Example |
| 57 | 8 | 88 | 3 | 12.5 | 945 | 1175 | 80 | 42 | 3.6 | ⊚ | Comparative Example |
| 58 | 0 | 80 | 4 | 15.0 | 1502 | 1861 | 81 | 31 | 4.6 | x | Comparative Example |
| 59 | 0 | 88 | 2 | 9.8 | 1120 | 1569 | 71 | 26 | 3.6 | x | Comparative Example |
| 60 | 15 | 85 | 0 | 5.0 | 987 | 1165 | 85 | 39 | 3.6 | ⊚ | Comparative Example |
| 61 | 0 | 82 | 2 | 15.0 | 1119 | 1524 | 73 | 22 | 4.3 | x | Comparative Example |
| 62 | 2 | 95 | 3 | 5.0 | 1268 | 1498 | 85 | 42 | 3.6 | ⊚ | Example |
| 63 | 1 | 95 | 2 | 7.5 | 1255 | 1512 | 83 | 41 | 3.9 | ∘ | Example |
| 64 | 1 | 88 | 1 | 10.0 | 1300 | 1521 | 85 | 43 | 3.9 | ⊚ | Example |
| 65 | 0 | 86 | 2 | 10.0 | 1365 | 1710 | 80 | 33 | 4.3 | ⊚ | Example |
| 66 | 0 | 87 | 1 | 10.0 | 1487 | 1801 | 83 | 33 | 4.3 | ⊚ | Example |
| 67 | 0 | 100 | 0 | 5.0 | 1262 | 1523 | 83 | 48 | 3.6 | ⊚ | Example |
| 68 | 1 | 85 | 4 | 12.5 | 1069 | 1325 | 81 | 32 | 3.6 | ⊚ | Example |
| 69 | 2 | 80 | 3 | 12.5 | 1365 | 1714 | 80 | 34 | 4.3 | ⊚ | Example |
| 70 | 1 | 95 | 4 | 5.0 | 1235 | 1521 | 81 | 31 | 4.3 | ∘ | Example |
| 71 | 3 | 95 | 2 | 7.5 | 1098 | 1324 | 83 | 51 | 3.6 | ⊚ | Example |
| 72 | 1 | 98 | 1 | 5.0 | 1265 | 1514 | 84 | 42 | 3.6 | ⊚ | Example |
| 73 | 0 | 99 | 1 | 7.5 | 1235 | 1498 | 82 | 45 | 3.6 | ⊚ | Example |
| 74 | 1 | 85 | 2 | 12.5 | 1502 | 1806 | 83 | 33 | 4.3 | ⊚ | Example |
| 75 | 3 | 65 | 2 | 17.5 | 1087 | 1334 | 81 | 49 | 4.6 | ∘ | Example |
| 76 | 0 | 83 | 3 | 10.0 | 1385 | 1535 | 90 | 32 | 4.3 | ⊚ | Example |
| 77 | 0 | 67 | 1 | 20.0 | 1325 | 1487 | 89 | 39 | 4.6 | ∘ | Example |
| 78 | 2 | 85 | 1 | 12.5 | 1387 | 1765 | 79 | 32 | 4.3 | ⊚ | Example |
| 79 | 0 | 90 | 0 | 7.5 | 1247 | 1489 | 84 | 48 | 3.9 | ⊚ | Example |
| 80 | 2 | 90 | 3 | 7.5 | 1235 | 1502 | 82 | 45 | 3.9 | ⊚ | Example |
| 81 | 0 | 92 | 0 | 7.5 | 1425 | 1758 | 81 | 32 | 4.3 | ⊚ | Example |
| 82 | 0 | 98 | 2 | 5.0 | 1234 | 1512 | 82 | 45 | 3.9 | ⊚ | Example |

The underline indicates outside the scope of the present disclosure.
The underline indicates outside the scope of the present disclosure.

As indicated in Table 3, Examples according to the present disclosure have high strength and are excellent in all of member strength, stretch flangeability, bendability, and delayed fracture resistance under atmospheric corrosion conditions in the coated state. On the other hand, in Comparative Examples, at least one of strength, member strength, stretch flangeability, bendability, and delayed fracture resistance under atmospheric corrosion conditions in the coated state is inferior.

While embodiments of the present disclosure have been described above, the present disclosure is not limited to the description that forms part of the present disclosure in relation to the embodiments. That is, a person skilled in the art may make various modifications to the embodiments, examples, and operation techniques disclosed herein, and all such modifications will still fall within the scope of the claims which follow. For example, in the above-described heat treatment series in the production method disclosed herein, any apparatus or the like may be used to perform the heat treatment on the steel sheet as long as the thermal hysteresis conditions are satisfied.

### INDUSTRIAL APPLICABILITY

According to the present disclosure, it is possible to produce a high-strength steel sheet that is excellent in all of member strength, stretch flangeability, bendability, and delayed fracture resistance under atmospheric corrosion conditions in the coated state. Moreover, for example, by applying the steel sheet obtained according to the method of the present disclosure to automotive structural members, it is possible to improve fuel efficiency by reducing vehicle weight. Therefore, the present disclosure is highly beneficial in industrial terms.

1. A steel sheet, comprising a chemical composition containing, in mass %,
C: 0.090% or more and 0.390% or less,
Si: 0.01% or more and 2.00% or less,
Mn: 2.00% or more and 4.00% or less,
P: 0.100% or less,
S: 0.0200% or less,
Al: 1.000% or less,
N: 0.0100% or less, and
O: 0.0100% or less,
with the balance being Fe and inevitable impurities, wherein,
at a ¼ thickness position of the steel sheet, the steel sheet comprises a microstructure satisfying:
an area ratio of tempered martensite is 75% or more,
an area ratio of fresh martensite is 15% or less,
a total area ratio of ferrite and bainite is 15% or less,
an area ratio of retained austenite is 15% or less, and
an average value [τq] of plastic deformation initiation stress τq measured by a nanoindentation method at the ¼ thickness position is 2.50 GPa or more and 4.10 GPa or less, and standard deviation σq of the plastic deformation initiation stress τq is 0.30 GPa or less, and
at a 10 μm position from a steel sheet surface, the steel sheet comprises a microstructure satisfying:
an area ratio of tempered martensite is 40% or less,
an area ratio of pearlite is 15% or less,
a total area ratio of ferrite and bainite is 60% or more, and
when an average value of plastic deformation initiation stress τs measured by a nanoindentation method at the 10 μm position is defined as [τs], a proportion of measurement points having values less than 0.85×[τs] is 25.0% or less.

2. The steel sheet according to claim 1, wherein the chemical composition further contains, in mass %, at least one element selected from the group consisting of:
Ti: 0.200% or less,
Nb: 0.200% or less,
V: 0.200% or less,
Ta: 0.10% or less,
W: 0.10% or less,
B: 0.0100% or less,
Cr: 1.00% or less,
Mo: 1.00% or less,
Ni: 1.00% or less,
Co: 0.010% or less,
Cu: 1.00% or less,
Sn: 0.200% or less,
Sb: 0.200% or less,
Ca: 0.0100% or less,
Mg: 0.0100% or less,
REM: 0.0100% or less,
Zr: 0.100% or less,
Te: 0.100% or less,
Hf: 0.10% or less, and
Bi: 0.200% or less.

3. The steel sheet according to claim 1, wherein the steel sheet has a coated or plated layer on a surface.

4. A member comprising the steel sheet according to claim 1.

5. An automotive frame structural part or an automotive reinforcement part comprising the member according to claim 4.

6. A method of producing a steel sheet, comprising:
preparing a steel slab having the chemical composition according to claim 1,
subjecting the steel slab to a hot rolling process in which rough rolling is performed under conditions that the number of passes in a temperature region of 1000° C. or higher is 4 or more, a rolling reduction ratio per pass is 15% or more, and an average strain rate is in a range of 9×10⁻⁴/s or more and 1×10⁻²/s or less, followed by finish rolling and then coiling to obtain a hot-rolled sheet, subjecting the hot-rolled sheet to a pickling and cold rolling process in which pickling and cold rolling are performed to obtain a cold-rolled sheet, then subjecting the cold-rolled sheet to annealing and then cooling the sheet to 150° C. or lower, and subsequently reheating the steel sheet, wherein
the annealing is performed under conditions that a heating temperature is 800° C. or higher, a dew point in the heating temperature region T1 of 800° C. or higher is −25° C. or higher, and the following Formula 1 is satisfied,
$$2. \leq K \leq 60. \qquad Formula 1$$
where
$$\begin{matrix}[ Math . 1 ] \\ K = {\sum }_{t = 1}^{tE} D ( {T}_{t} ) \times {10}^{6} ,\end{matrix}$$
$$D ( {T}_{t} ) = ( 0.07 + 0.06 [ \% C ] ) * exp ( - \frac{32000}{1.986 \times ( {T}_{t} + 273 )} )$$
where
[% C] represents a carbon content in the steel sheet, and
the time when the temperature of the cold-rolled sheet first reaches 800° C. during heating in the annealing is defined as t=0 (s), and t=tE (s) is the time when the annealing is completed and the temperature of the cold-rolled sheet again becomes 800° C., and Tₜ (° C.) is an average temperature of the cold-rolled sheet during time t: t−1 to t (s),
during the cooling,
an average cooling rate v2 in a temperature region T2 of 600° C. or higher and 750° C. or lower is 1.0° C./s or higher and 15.0° C./s or lower,
an average cooling rate in a temperature region of 500° C. or higher and lower than 600° C. is higher than the v2,
a holding time in a temperature region T3 of 400° C. or higher and lower than 500° C. is 10 s or more and 150 s or less,
an average cooling rate v4 in a temperature region T4 of Ms−100° C. or higher and Ms ° C. or lower is 3.0° C./s or higher, and
the reheating is performed under conditions that the maximum arrival temperature X of the reheating and the holding time Y at X−10° C. or higher satisfy the following Formula (2)
$$8000 \leq ( 273 + X ) \times ( 20 + Log ( Y / 3600 ) ) \leq 12000 \qquad Formula ( 2 )$$
where the unit of the temperature X is ° C., and the unit of the holding time Y is second.

7. The method of producing a steel sheet according to claim 6,
wherein coating or plating treatment is further performed during the cooling.

8. A method of producing a member, comprising subjecting the steel sheet according to claim 1 to either or both of forming processing and joining processing to obtain a member.

9. The steel sheet according to claim 2, wherein the steel sheet has a coated or plated layer on a surface.

10. A member comprising the steel sheet according to claim 2.

11. A member comprising the steel sheet according to claim 3.

12. A member comprising the steel sheet according to claim 9.

13. An automotive frame structural part or an automotive reinforcement part comprising the member according to claim 10.

14. An automotive frame structural part or an automotive reinforcement part comprising the member according to claim 11.

15. An automotive frame structural part or an automotive reinforcement part comprising the member according to claim 12.

16. A method of producing a steel sheet, comprising:
preparing a steel slab having the chemical composition according to claim 2,
subjecting the steel slab to a hot rolling process in which rough rolling is performed under conditions that the number of passes in a temperature region of 1000° C. or higher is 4 or more, a rolling reduction ratio per pass is 15% or more, and an average strain rate is in a range of 9×10⁻⁴/s or more and 1×10⁻²/s or less, followed by finish rolling and then coiling to obtain a hot-rolled sheet, subjecting the hot-rolled sheet to a pickling and cold rolling process in which pickling and cold rolling are performed to obtain a cold-rolled sheet, then subjecting the cold-rolled sheet to annealing and then cooling the sheet to 150° C. or lower, and subsequently reheating the steel sheet, wherein
the annealing is performed under conditions that a heating temperature is 800° C. or higher, a dew point in the heating temperature region T1 of 800° C. or higher is −25° C. or higher, and the following Formula 1 is satisfied,
$$2. \leq K \leq 60. \qquad Formula 1$$
where
$$\begin{matrix}[ Math . 1 ] \\ K = {\sum }_{t = 1}^{tE} D ( {T}_{t} ) \times {10}^{6} ,\end{matrix}$$
$$D ( {T}_{t} ) = ( 0.07 + 0.06 [ \% C ] ) * exp ( - \frac{32000}{1.986 \times ( {T}_{t} + 273 )} )$$
where
[% C] represents a carbon content in the steel sheet, and
the time when the temperature of the cold-rolled sheet first reaches 800° C. during heating in the annealing is defined as t=0 (s), and t=tE (s) is the time when the annealing is completed and the temperature of the cold-rolled sheet again becomes 800° C., and Tₜ (° C.) is an average temperature of the cold-rolled sheet during time t: t−1 to t (s),
during the cooling,
an average cooling rate v2 in a temperature region T2 of 600° C. or higher and 750° C. or lower is 1.0° C./s or higher and 15.0° C./s or lower,
an average cooling rate in a temperature region of 500° C. or higher and lower than 600° C. is higher than the v2,
a holding time in a temperature region T3 of 400° C. or higher and lower than 500° C. is 10 s or more and 150 s or less,
an average cooling rate v4 in a temperature region T4 of Ms−100° C. or higher and Ms ° C. or lower is 3.0° C./s or higher, and
the reheating is performed under conditions that the maximum arrival temperature X of the reheating and the holding time Y at X−10° C. or higher satisfy the following Formula (2)
$$8000 \leq ( 273 + X ) \times ( 20 + Log ( Y / 3600 ) ) \leq 12000 \qquad Formula ( 2 )$$
where the unit of the temperature X is ° C., and the unit of the holding time Y is second.

17. The method of producing a steel sheet according to claim 16, wherein coating or plating treatment is further performed during the cooling.

18. A method of producing a member, comprising subjecting the steel sheet according to claim 2 to either or both of forming processing and joining processing to obtain a member.

19. A method of producing a member, comprising subjecting the steel sheet according to claim 3 to either or both of forming processing and joining processing to obtain a member.

20. A method of producing a member, comprising subjecting the steel sheet according to claim 9 to either or both of forming processing and joining processing to obtain a member.
